(19) United States
(12) Patent Application Publication
(10) Pub. No.: US 2008/0061462 A1
(43) Pub. Date: Mar. 13, 2008

(54) Production method of multilayer film and production apparatus of the same

(75) Inventor: Naoki Nakamura, Kanagawa (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/980,516

(22) Filed: Oct. 31, 2007

(30) Foreign Application Priority Data
Jan. 11, 2006 (JP) 2006-297260

(51) Int. Cl. B29C 41/28; B29C 41/32; B29C 67/02

(52) U.S. Cl. 264/40.7; 264/172.19; 425/224; 425/363; 425/373

(57) ABSTRACT

A feed block includes first to third flow channels. The second and third flow channels are connected to the first flow channels in a joint portion. Each of an intermediate layer dope, a bottom layer dope, and a top layer dope flows in the first, second, and third flow channels, respectively, and joined together at the joint portion to form a multilayer dope. The flow rate of the bottom layer dope at the vicinity of an inlet of the second flow channel is denoted by U1, and the flow rate in an upstream side from a pin is denoted by U2. A pump and the pin are controlled. When U2/U1 is not less than 3 and not more than 10, disturbance of an interface between the intermediate layer dope and the bottom layer dope in the multilayer dope is reduced, and thereby it is possible to reduce unevenness in thickness of the multilayer dope due to the disturbance of the interface. Since the disturbance of the interface often occurs in the multilayer casting method at high speed casting speed, the present invention is effectively applicable thereto.

### FIELD OF THE INVENTION

The present invention relates to a production method of multilayer film and a production method of the same.

### BACKGROUND OF THE INVENTION

A polymer film (hereinafter abbreviated as “film”) has advantages such as excellent light transmission property and flexibility, and can be made lighter and thinner. Accordingly, the film is widely used as an optical functional film. In particular, a cellulose ester film containing cellulose acylate or the like further has advantages such as toughness, low optical anisotropy, and low retardation value, in addition to being inexpensive. Therefore, the cellulose ester film is widely utilized as a protective film for a polarizing filter, an optical compensation film, an anti-reflection film, and a wideview film as components of a liquid crystal display device (LCD).

A solution casting method is used to produce the optical functional films described above. In comparison with other production methods such as a melt casting method, it is possible to produce a film having more excellent optical properties in the solution casting method. In the solution casting method, after a polymer is dissolved into solvent (mainly organic solvent) to prepare a dope, the dope is cast onto a support such as a band and a drum to form a casting film. Then, the casting film is dried or cooled, and peeled from the support to be dried, thus obtaining a film.

In a case where the film is used as the optical functional film such as a support for photosensitive material or optical material, as a matter of course, it is necessary for the film to have excellent optical properties or the like as described above. In addition to this, it is required that the film has smoothness as a whole. To control unevenness in thickness which causes unevenness in the optical properties is an important problem in the production method of the optical functional film.

When the casting film just after casting has unevenness in thickness and used as it is in order to form a film, there occurs unevenness in thickness of the film as a final product. In a case where unevenness in thickness occurs on the casting film, it becomes difficult to perform the following processes such as a dry process on the entire film uniformly. Therefore, there occurs unevenness in the shape or the optical properties. Accordingly, before forming the casting film, that is, at the time of casting the bead, it is necessary to remove unevenness in thickness thereof. However, at the present time, there is no method for smoothing the surface of the casting bead during casting. As a method for producing optical functional film capable of reducing unevenness in the thickness thereof, there is often used a multilayer casting method in which a multilayer including a layer for forming a main part of the optical functional layer (hereinafter, referred to as a main layer) and a layer formed on, one surface or each surface of the main layer so as to be exposed outside (hereinafter, referred to as a surface layer) can be produced, instead of the solution casting method described above.

As disclosed in Japanese Patent Laid-Open Publication No. 2002-221620, a feed block is used in the solution casting method in order to feed polymer solution having high viscosity and polymer solution having low viscosity through a separate flow channel as a flow of polymer solution having high viscosity and a flow of polymer solution having low viscosity, respectively. The flows are joined together at a join portion of the feed block to produce a multilayer dope including the main layer and the surface layer. The multilayer dope is cast onto the support from a casting die to form a multilayer casting film. The multilayer casting film after being dried or cooled is peeled from the support and subjected to predetermined following processes such as a dry process, thus obtaining the multilayer film as a final product. In the multi-layer casting method, a dope suitable for enhancing strength and optical properties of the film is used as a main layer forming dope, and a dope for improving smoothness and lubricant properties is used as a surface layer forming dope. Here, lubricant properties mean sliding ability of a film. Accordingly, it is possible to increase the smoothness and lubricant properties on the surface of the optical functional film without decreasing toughness and the optical properties of the optical functional layer as a whole.

Recently, in accordance with the sharp demand expansion for flat panel display including LCD, organic electroluminescent (EL) display, and the like, the improvement in film forming speed is highly desired in the multilayer casting method. The improvement in casting speed of the multilayer dope is necessary for the purpose of reducing the time required for the multilayer casting method. However, the multilayer dope discharged from a die lip has thickness unevenness in the width direction, and in particular, when the casting speed of the multilayer dope is 100 m/min (conventional casting speed: less than 100 m/min) at the lip of the casting die, the occurrence of the unevenness in thickness becomes more frequent.

As a result of a keen examination, the inventor of the present invention found that unevenness in thickness of multilayer dope just after being cast in accordance with the increase in the casting speed is caused by disturbance of an interface between the main layer and the surface layer at the joint portion of the feed block, and that the disturbance of the interface can be reduced by setting the casting speed of the main layer forming dope and the surface layer forming dope at an inlet of the feed block and the joint portion to a predetermined condition.

### SUMMARY OF THE INVENTION

In view of the above, an object of the present invention is to provide a production method of multilayer film capable of reducing disturbance of an interface between layers in a multilayer dope at a high casting speed and unevenness in thickness, and a production apparatus of the same.

To achieve the above object, according to the present invention, there is provided a production method of multilayer film having a plurality of layers characterized by including the steps of: supplying a first dope through a first inlet of a casting die into the casting die, the casting die flowing out the first dope and a second dope different from each other; supplying the second dope through a second inlet of the casting die into the casting die; and joining the first dope having passed through a first flow channel and the second dope having passed through a second flow channel together in a joint portion provided in the casting die to form a multilayer dope. The first flow channel connects the first inlet and the joint portion, the second flow channel connects the second inlet and the joint portion and has a cross section being gradually smaller toward the joint portion from the second inlet in a direction perpendicular to a flow direction of the second dope. A value of Vo2/Vi2 is approximately constant in a range of 3 to 10 when Vo2 is a flow rate of the second dope in the joint portion and Vi2 is a flow rate of the second dope at the second inlet. The multilayer dope is cast from the casting die onto a moving support to form a multilayer casting film. The multilayer casting film is peeled as a wet film from the support. The wet film is dried to be a multilayer film.

A viscosity of the second dope is preferably lower than a viscosity of the first dope. A value of Vo2/Vo1 is approximately constant in a range of 0.1 to 1 when Vo1 is a flow rate of the first dope in the joint portion.

The first dope is preferably sent to the join portion through the first flow channel having a cross section being approximately constant toward the joint portion from the first inlet in a direction perpendicular to a flow direction of the first dope. Moreover, preferably, the flow rate Vi2 of the second dope at the second inlet is adjusted by a second dope supplying device for supplying the second dope to the second inlet, and the flow rate Vo2 of the second dope in the joint portion is adjusted by an adjusting device provided at the second flow channel at the vicinity of the joint portion. Further, preferably, the flow rate Vo1 of the first dope in the joint portion is adjusted by a first dope supplying device for supplying the first dope to the first inlet, and the flow rate Vo2 of the second dope in the joint portion is adjusted by an adjusting device provided at the second flow channel at the vicinity of the joint portion.

Moreover, according to the present invention, there is provided a production apparatus of multilayer film having a plurality of layers characterized by including: a moving support; a casting die for flowing out a first dope and a second dope different from each other onto the support to form a multilayer casting film such that the first dope and the second dope are stacked, the first dope being guided through a first inlet included in the casting die, the second dope being guided through a second inlet included in the casting die, and the first dope and the second dope being joined together in a joint portion of the casting die to form a multilayer dope; a first dope supplying device for supplying the first dope to the casting die; a second dope supplying device for supplying the second dope to the casting die; an adjusting device for adjusting a flow rate Vo2 of the second dope in the joint portion; a controlling device for controlling the second dope supplying device and the adjusting device such that a value of Vo2/Vi2 is approximately constant in a range of 3 to 10, Vi2 being a flow rate of the second dope at the second inlet; and a drier for drying the multilayer casting film peeled from the support to form a multilayer film.

It is preferable that any one of the first dope supplying device, the second dope supplying device, and the adjusting device is controlled by the controlling device such that a value of Vo2/Vo1 is approximately constant in a range of 0.1 to 1 when Vo1 is a flow rate of the first dope in the joint portion.

The production apparatus of multilayer film of the present invention preferably includes a first flow channel connecting the first inlet and the joint portion and having a cross section being approximately constant toward the joint portion from the first inlet in a direction perpendicular to a flow direction of the first dope.

The adjusting device is preferably a distribution pin for adjusting the cross section of the second flow channel at the vicinity of the joint portion.

It is preferable that the casting die includes a feed block for forming the multilayer dope from the first dope and the second dope, and a die main body for casting the multilayer dope formed in the feed block to the support.

According to the production method of multilayer film and the production apparatus of the same of the present invention, since it is possible to reduce the disturbance of the interface between layers in the multilayer dope at a high casting speed, it is also possible to reduce unevenness in thickness of multilayer dope caused by disturbance of the interface. Further, in the production method of multilayer film and the production apparatus of the same according to the present invention, since the casting method and the casting device described above are used, it is possible to produce a large amount of multilayer films while reducing thickness unevenness and unevenness in optical properties caused by the thickness unevenness at short times.

### BRIEF DESCRIPTION OF THE DRAWINGS

One with ordinary skill in the art would easily understand the above-described objects and advantages of the present invention when the following detailed description is read with reference to the drawings attached hereto:

FIG. 1 is an explanatory view schematically illustrating a dope production line according to an embodiment of the present invention;

FIG. 2 is an explanatory view schematically illustrating a film production line for use in a multilayer casting method;

FIG. 3 is a perspective view illustrating a feed block and the vicinity thereof in an enlarged manner;

FIG. 4 is a cross-sectional view illustrating a multilayer casting film formed on a casting band;

FIG. 5 is a cross-sectional view along the line V-V of FIG. 3;

FIG. 6 is a cross-sectional view illustrating the feed block;

FIG. 7 is a perspective view illustrating a distribution pin;

FIG. 8 is a cross-sectional view illustrating the distribution pin; and

FIG. 9 is a cross-sectional view along the line IX-IX of FIGS. 3 and 5.

### DESCRIPTION OF THE PREFERRED EMBODIMENTS

Embodiments of the present invention are described hereinbelow. The present invention, however, is not limited to the following embodiments.

[Material]

Cellulose acylate is preferably triacetyl cellulose (TAC) In TAC, it is preferable that the degree of the acyl substitution for hydrogen atoms in hydroxyl groups in cellulose satisfies all of the following formulae (I) to (III):
2.5≦A+B≦3.0 (I)
0≦A≦3.0 (II)
0≦B≦2.9 (III)
In the above formulae (I) to (III), “A” represents a degree of substitution of the hydrogen atom in the hydroxyl group to the acetyl group in cellulose, while “B” represents a degree of substitution of the hydrogen atom in the hydroxyl group to the acyl group with 3 to 22 carbon atoms in cellulose. Preferably, at least 90 wt % of TAC particles have a diameter in the range of 0.1 mm to 4 mm, respectively. Note that, the polymer capable of being used in the present invention is not limited to TAC. The polymer may be any well-known substance as long as the substance can be dissolved into the solvent and serve as a dope.

Cellulose has glucose units making β-1,4 bond, and each glucose unit has a liberated hydroxyl group at second, third, and sixth positions. Cellulose acylate is a polymer in which a part of or the whole of the hydroxyl groups are esterified so that the hydrogen is substituted by the acyl group with two or more carbons. The degree of substitution for the acyl groups in cellulose acylate means a degree of esterification of the hydroxyl group at each of the second, the third, and the sixth positions in cellulose (when the whole (100%) of the hydroxyl group at the same position is substituted, the degree of substitution at this position is 1).

The total degree of substitution for the acyl groups, namely DS2+DS3+DS6, is preferably in the range of 2.00 to 3.00, more preferably in the range of 2.22 to 2.90, and most preferably in the range of 2.40 to 2.88. In addition, DS6/(DS2+DS3+DS6) is preferably at least 0.28, more preferably at least 0.30, and most preferably in the range of 0.31 to 0.34. Note that DS2 is the degree of substitution of the hydrogen atom in the hydroxyl group at second position per glucose unit to the acyl group (hereinafter referred to as a degree of acyl substitution at second position), DS3 is the degree of substitution of the hydrogen atom in the hydroxyl group at third position per glucose unit to the acyl group (hereinafter referred to as a degree of acyl substitution at third position), and DS6 is the degree of substitution of the hydrogen atom in the hydroxyl group at sixth position per glucose unit to the acyl group (hereinafter referred to as a degree of acyl substitution at sixth position).

In the present invention, the kind of the acyl groups in cellulose acylate can be one or more. When two or more kinds of acyl groups are in cellulose acylate, it is preferable that one of them is the acetyl group. When a total degree of substitution of the hydroxyl group at the second, the third, and the sixth positions to the acetyl groups and that to acyl groups other than acetyl groups are described as DSA and DSB, respectively, the value of DSA+DSB is preferably in the range of 2.2 to 2.90, and more preferably in the range of 2.40 to 2.88. In addition, DSB is preferably at least 0.30, and more preferably at least 0.7. In the DSB, the percentage of the substitution of the hydroxyl group at the sixth position is preferably at least 20%, more preferably at least 25%, and most preferably at least 33%. Furthermore, the value of DSA+DSB, in which the hydroxyl group is at the sixth position in cellulose acylate, is preferably at least 0.75, more preferably at least 0.80, and most preferably at least 0.85. By using such cellulose acylate that satisfies the above conditions, a solution (dope) with excellent solubility can be prepared. Especially, since using a non-chlorine organic solvent represents excellent solubility, it is possible to produce the dope with low viscosity and excellent filterability.

Although cellulose as a material of cellulose acylate may be obtained from either linter or pulp, the linter is preferably used.

According to the present invention, as for cellulose acylate, the acyl group having at least 2 carbon atoms may be either aliphatic group or aryl group, and is not especially limited. As examples of the cellulose acylate, there are alkylcarbonyl ester, alkenylcarbonyl ester, aromatic carbonyl ester, aromatic alkylcarbonyl ester, and the like. Cellulose acylate may be also esters having other substituents. Preferable substituents are, for example, propionyl group, butanoyl group, pentanoyl group, hexanoyl group, octanoyl group, decanoyl group, dodecanoyl group, tridecanoyl group, tetradecanoyl group, hexadecanoyl group, octadecanoyl group, iso-butanoyl group, t-butanoyl group, cyclohexane carbonyl group, oleoyl group, benzoyl group, naphthylcarbonyl group, cinnamoyl group, and the like. Among them, more preferable groups are propionyl group, butanoyl group, dodecanoyl group, octadecanoyl group, t-butanoyl group, oleoyl group, benzoyl group, naphtyl carbonyl group, cinnamoyl group, and the like. Particularly, propionyl group and butanoyl group are most preferable.

As a solvent to be used for preparing the dope, there are aromatic hydrocarbon (for example, benzene, toluene, and the like), halogenated hydrocarbon (for example, dichloromethane, chlorobenzene, and the like), alcohol (for example, methanol, ethanol, n-propanol, n-butanol, diethyleneglycol, and the like), ketone (for example, acetone, methylethyl ketone, and the like), ester (for example, methylacetate, ethylacetate, propylacetate, and the like), ether (for example, tetrahydrofuran, methyl cellosolve, and the like), and the like. Note that in the present invention the dope means a polymer solution or dispersion solution that is obtained by dissolving or dispersing the polymer in the solvent.

The halogenated hydrocarbon preferably has 1 to 7 carbon atoms, and is most preferably dichloromethane. In view of physical properties of the TAC, such as solubility, peelability of a casting film from the support, a mechanical strength of the film, and optical properties of the film, it is preferable to use at least one kind of alcohol having 1 to 5 carbon atoms together with dichloromethane. The content of alcohol is preferably in the range of 2 wt % to 25 wt %, and more preferably in the range of 5 wt % to 20 wt % relative to the whole solvent. Applicable alcohols are, for example, methanol, ethanol, n-propanol, iso-propanol, n-butanol, and the like, and especially methanol, ethanol, n-butanol, and a mixture of them are more preferable among them.

Recently, in order to reduce adverse influence on the environment to the minimum, a solvent containing no dichloromethane is proposed. In this case, the solvent preferably contains ether with 4 to 12 carbon atoms, ketone with 3 to 12 carbon atoms, ester with 3 to 12 carbon atoms, and more preferably contains methyl acetate. The solvent also contains a mixture of them. Note that ether, ketone, and ester may have a cyclic structure. A compound having at least two functional groups thereof (that is, —O—, —CO—, and —COO—) may be used as the solvent. The solvent may contain other functional groups such as alcoholic hydroxyl groups. In a case where the solvent includes two or more functional groups, it is sufficient that the number of carbon atoms is within a predetermined range of compound that includes any functional group.

Details regarding cellulose acylate are described in paragraphs [0140] to [0195] in Japanese Patent Laid-Open Publication No. 2005-104148. The description is also applicable to the present invention. Further, details regarding the solvents and the additives (such as a plasticizer, a deterioration inhibitor, a UV-absorbing agent, an optical anisotropy controller, a retardation controller, dye, a matting agent, a release agent, and the like) are also described in paragraphs [0196] to [0516] in the same publication.

[Dope Production Method]

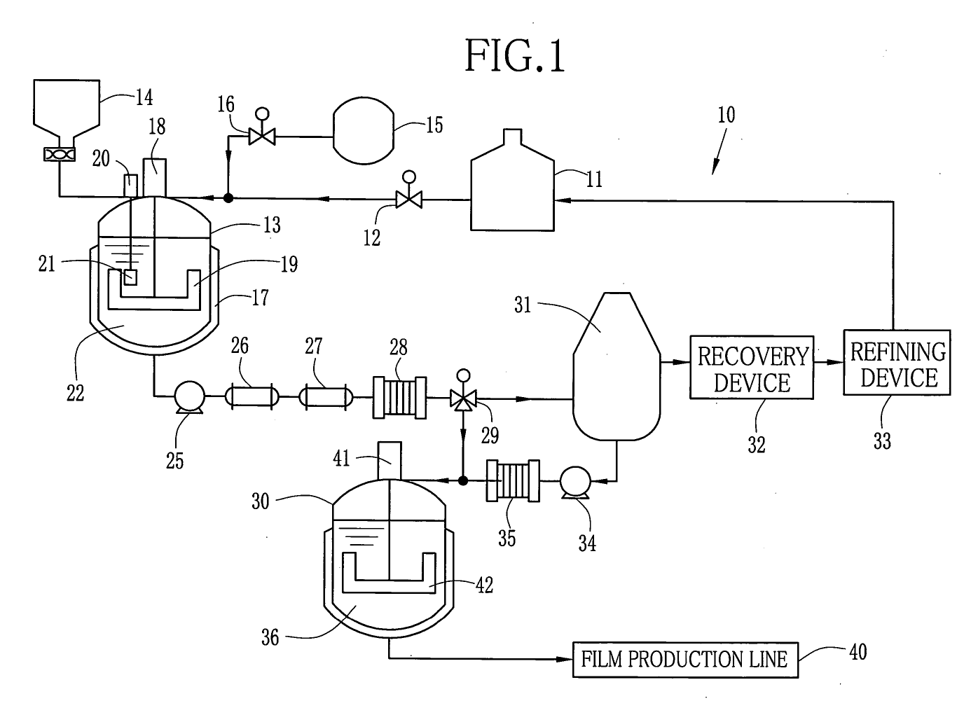

As shown in FIG. 1, a dope production line 10 includes a solvent tank 11 for storing a solvent, a dissolving tank 13 for mixing the solvent and TAC or the like, a hopper 14 for supplying the TAC, an additive tank 15 for storing an additive liquid, a heater 26 for heating a swelling liquid to be described later, a temperature regulator 27 for regulating the temperature of a prepared dope, a filtration device 28, a flash device 31 for concentrating the prepared dope, a filtration device 35, a recovery device 32 for recovering the solvent, and a refining device 33 for refining the recovered solvent. The dope production line 10 is connected to a film production line 40 via a stock tank 30.

First of all, a valve 12 disposed in a pipe connecting the solvent tank 11 with the dissolving tank 13 is opened, and the solvent is sent from the solvent tank 11 to the dissolving tank 13. Next, the TAC stored in the hopper 14 is supplied to the dissolving tank 13 while its mount is measured. A predetermined amount of additive liquid is supplied to the dissolving tank 13 from the additive tank 15 by opening/closing a valve 16 disposed in a pipe connecting the additive tank 15 and the dissolving tank 13. Note that, in a case where the additive is liquid at room temperature, it is possible to send the additive in a liquid state to the dissolving tank 13, in addition to supplying as solution. Further, in a case where the additive is solid, the hopper can be used to supply the additive to the dissolving tank 13. Further, in a case where plural kinds of additives are to be added, the additive tank 15 may contain a solution in which plural kinds of solvents are dissolved. Additionally, it is possible that plural additive tanks are used in accordance with the kinds of the solutions containing each additive, and each additive is supplied to the dissolving tank 13 through independent pipes.

Although the solvent (including a mixed solvent), the TAC, and the additive are supplied to the dissolving tank 13 in this order in the above description, the order is not limited thereto. For example, after supplying the TAC to the dissolving tank 13 while measuring its amount, an adequate amount of the solvent may be supplied thereto. Further, it is not always necessary to preliminarily supply the additive to the dissolving tank 13, and the additive may be mixed with a mixture of the TAC and the solvent (hereinafter in some cases referred to as dope) in the following process.

The dissolving tank 13 is provided with a jacket 17 for covering an outer surface thereof, a first stirrer 19 rotated by a motor 18. Additionally, the dissolving tank 13 is preferably provided with a second stirrer 21 rotated by a motor 20. Note that the first stirrer 19 is preferably provided with an anchor blade, and the second stirrer 21 is preferably a decentering stirrer of dissolver type. The temperature in the dissolving tank 13 is regulated by pouring a heat transfer medium into the jacket 17. A preferable temperature range in the dissolving tank 13 is not less than −10° C. and not more than 55° C. The first stirrer 19 and the second stirrer 21 are arbitrarily selected and rotated to prepare a swelling liquid 22 in which the TAC is swelled in the solvent.

The swelling liquid 22 prepared in the dissolving tank 13 is supplied to the heater 26 by a pump 25. Preferably, the heater 26 includes a pipe provided with a jacket, and applies pressure to the swelling liquid 22. While the swelling liquid 22 is heated or the swelling liquid 22 is pressurized and heated, the TAC or the like is dissolved into the solvent to obtain the dope. Note that, the preferable temperature range of the swelling liquid 22 is not less than 0° C. and not more than 97° C. in this case. A heat-dissolving method and a cooling-dissolving method are arbitrarily selected to be performed, and the TAC can be dissolved into the solvent sufficiently. The temperature of the prepared dope is regulated by the temperature regulator 27 such that the temperature of the dope becomes approximately a room temperature. After passing the temperature regulator 27, the dope is filtered by the filtration device 28 to remove impurities therefrom. An average diameter of the pores of a filtration filter used for the filtration device 28 is preferably not more than 100 μm. The filtering flow rate is preferably equal to or more than 50 L/h. Thereafter, the dope after filtration is supplied to the stock tank 30 via valve 29.

The method for dissolving the TAC after preparing the swelling liquid 22 takes longer time when the concentration of the TAC is higher. Therefore, there arises a problem in that the manufacturing cost increases. In this case, a concentration process is preferably performed. In the concentration process, after the dope having a concentration lower than a desired TAC concentration is prepared, the dope having a low concentration is concentrated to obtain the dope having a desired concentration. The dope filtered by the filtration device 28 is supplied to the flash device 31 via a valve 29. The flash device 31 evaporates a part of the solvent in the dope. Solvent gas generated due to the evaporation of the solvent in the flash device 31 is condensed to be liquidized by a condenser (not shown), and recovered by the recovery device 32. The recovered solvent is refined by the refining device 33 to be a solvent for preparing the dope, and reused, thus causing advantageous result in view of the cost.

The dope thus concentrated is taken out of the flash device 31 by a pump 34. Further, it is preferable that a defoaming process is performed in order to remove the bubbles contained in the dope. As the deforming process, various well-known methods are applicable. For example, there is an ultrasonic irradiation method. Thereafter, the dope is sent to the filtration device 35 to remove foreign substances therefrom. Note that the temperature of the dope is preferably not less than 0° C. and not more than 200° C. at this time. Then, the dope is supplied to the stock tank 30.

According to the methods described above, it is possible to produce the dope having the TAC concentration of 5 wt % to 40 wt %. Note that the produced dope (hereinafter referred to as dope 36) is stored in the stock tank 30.

The above-described dissolving method, the filtration method, the defoaming method, and the adding method of the materials and additives performed in the dope production line 10 are described in detail in paragraphs [0517] to [0616] in Japanese Patent Laid-Open Publication No. 2005-104148. The description is also applicable to the present invention.

[Solution Casting Method]

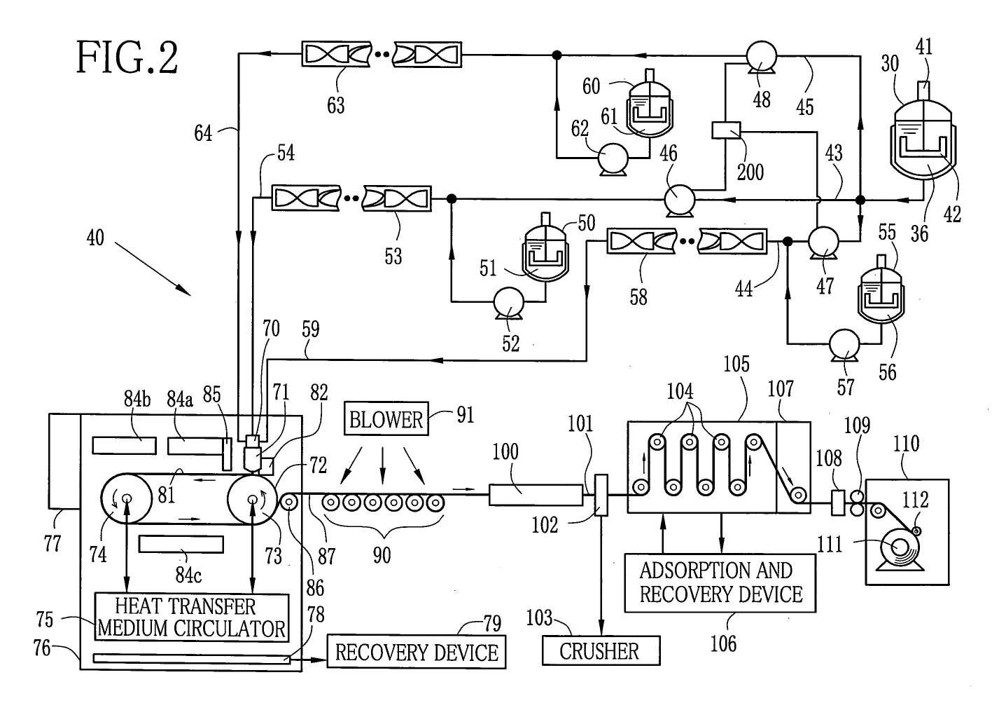

Hereinafter, a film composed of three layers is described. The three layers are an intermediate layer, a bottom layer, and a top layer. In the present invention, as described in detail later, a casting section includes a support, a casting die, a pump, a distribution pin, a controller, and a drying device. As shown in FIG. 2, the stock tank 30 is provided with a stirrer 42 rotated by a motor 41. The dope 36 is stirred by rotating the stirrer 42 such that the concentration of the dope 36 is always kept constant. An intermediate layer dope channel 43, a bottom layer dope channel 44, and a top layer dope channel 45 are connected between the stock tank 30 and a feed block to be described later. The dope 36 is supplied via pumps 46, 47, and 48 disposed in channels 43, 44, and 45, respectively. The pumps 46, 47, and 48 are connected to a controller 200. The controller 200 controls the pumps 46, 47, and 48 to supply a predetermined amount of the dope.

[Pump]

The pumps 46, 47, and 48 supply a predetermined flow volume of an intermediate dope 54, a bottom layer dope 59, and a top layer dope 64, respectively to a feed block 70. The pumps 46, 47, and 48 are preferably gear pumps. The gear pumps may be any well known one.

A stock tank 50 is connected to the intermediate layer dope channel 43 via a pipe. The stock tank 50 stores a liquid to be added to the intermediate layer (hereinafter referred to as intermediate layer additive liquid 51). A pump 52 is disposed in a pipe connecting the intermediate layer dope channel 43 and the stock tank 50. The intermediate layer additive liquid 51 stored in the stock tank 50 is supplied to the intermediate layer dope channel 43 via the pump 52, and added to the dope 36 contained in the intermediate layer dope channel 43. Thereafter, the dope 36 and the intermediate layer additive liquid 51 are stirred and mixed together to be uniform by a static mixer 53 disposed in the intermediate layer dope channel 43. Hereinafter, the dope thus obtained is referred to as intermediate layer dope 54. The intermediate layer additive liquid 51 includes a solution (or a dispersion liquid) to which an additive such as a UV-absorbing agent, retardation controller, and plasticizer is preliminarily added.

A stock tank 55 is connected to a bottom layer dope channel 44 via a pipe. The stock tank 55 stores a liquid to be added to the bottom layer (hereinafter referred to as bottom layer additive liquid 56). A pump 57 is disposed in a pipe connecting the bottom layer dope channel 44 and the stock tank 55. The bottom layer additive liquid 56 stored in the stock tank 55 is supplied to the bottom layer dope channel 44 via the pump 57, and added to the dope 36 contained in the bottom layer dope channel 44. Thereafter, the dope 36 and the bottom layer additive liquid 56 are stirred and mixed together to be uniform by a static mixer 58 disposed in the bottom layer dope channel 44. Hereinafter, the dope thus obtained is referred to as bottom layer dope 59. The bottom layer additive liquid 56 preliminarily contains an additive such as a release improver (such as citrate ester) for facilitating releasing from the casting band as the support, a matting agent (such as silicon dioxide) for reducing the adhesion between the surfaces of the film in winding a film in a roll manner, and a deterioration inhibitor. Note that the bottom layer additive liquid 56 may include an additive such as a plasticizer, an optical property controller such as UV-absorbing agent and retardation controller.

A stock tank 60 is connected to a top layer dope channel 45 via a pipe. The stock tank 60 stores a liquid to be added to the top layer (hereinafter referred to as top layer additive liquid 61). A pump 62 is disposed in a pipe connecting the top layer dope channel 45 and the stock tank 60. The top layer additive liquid 61 stored in the stock tank 60 is supplied to the top layer dope channel 45 via the pump 62, and added to the dope 36 contained in the top layer dope channel 45. Thereafter, the dope 36 and the top layer additive liquid 61 are stirred and mixed together to be uniform by a static mixer 63 disposed in the top layer dope channel 45. Hereinafter, the dope is referred to as top layer dope 64. The top layer additive liquid 61 preliminarily includes an additive such as a matting agent (such as silicon dioxide) for reducing the adhesion between the surfaces of the film in winding a film in a roll manner and a deterioration inhibitor. Note that the top layer additive liquid 61 may include an additive such as a release improver, a plasticizer, an optical property controller such as UV-absorbing agent and retardation controller.

[Dope Viscosity]

In this embodiment, the intermediate layer dope 54 is used for forming a main layer (hereinafter referred to as main layer forming dope), and each of the bottom layer dope 59 and the top layer dope 64 is used as a dope for forming a surface layer (hereinafter referred to as surface layer forming dope). As the main layer forming dope, a dope suitable for increasing the strength and optical functional properties of the optical functional layer to be produced is used. As the surface layer forming dope, a dope for increasing smoothness and lubricant properties of the optical functional layer is used. Further, in addition to this, it is preferable that a dope having a viscosity lower than that of the main layer forming dope is used as the surface layer forming dope. Thereby, it is possible to prevent generation of streaks and thickness unevenness on a surface of the multilayer casting film or a wet film in a dry process as described later.

A casting die consists of a die main body 71 and a feed block 70. The die main body 71 is provided so as to connect with the downstream side of the feed block 70. In the downstream side from the die main body 71, a casting band 72 is provided so as to be bridged over rotational rollers 73 and 74. A predetermined amount of each of the intermediate layer dope 54, the bottom layer dope 59, and the top layer dope 64 is supplied to the feed block 70 via pumps 46, 47, and 48, respectively. The intermediate layer dope 54, the bottom layer dope 59, and the top layer dope 64 are joined together in the feed block 70 to be a multilayer casting layer dope to be described later, and sent to the die main body 71. Note that the feed block 70, the die main body 71, and the multilayer casting layer dope are described in detail later.

The casting band 72 endlessly moves in accordance with the rotation of rotational rollers 73 and 74 caused by a driver (not shown). The moving speed of the casting die 72 is preferably in the range of 10 m/min to 200 m/min. Further, a heat transfer medium circulator 75 is preferably attached to the rotational rollers 73 and 74 such that the surface temperature of the casting band 72 is set to a desired value. The surface temperature of the casting band 72 is preferably in the range of −20° C. to 40° C. A transfer medium flow channel is formed in each of the rotational rollers 73 and 74. The heat transfer medium kept at a predetermined temperature passes through each of the transfer medium flow channels, and thereby it is possible to keep the temperature of each of the rotational rollers 73 and 74 at a predetermined value.

Although the width of the casting band 72 is not especially limited, it is preferable that the width thereof is approximately 1.1 to 3.0 times the casting width of the dope, the length thereof is in the range of 10 m to 200 m, and the width thereof is in the range of 0.3 mm to 10 mm. Further, it is preferable that the surface of the casting band 72 is ground as many times as possible such that the surface roughness becomes 0.05 μm or less. The casting band 72 is preferably made of stainless, and more preferably made of SUS316 so as to have sufficient resistance to corrosion and strength. Moreover, unevenness in thickness of the casting band 72 as a whole is preferably reduced to 0.5% or less.

The driving of the rotational rollers 73 and 74 is preferably controlled such that the tension caused in the casting band 72 becomes 1.5×10⁴×9.8 N/m, and is adjusted such that the difference in relative speed between the casting band 72 and the rotational rollers 73, 74 becomes 0.01 m/min or less. It is preferable that the speed fluctuation of the casting band 72 is adjusted to 0.5% or less, and meandering of the casting band 72 in the width direction caused by one rotation is reduced within 1.5 mm. It is more preferable that a detector (not shown) for detecting positions of side ends of the casting band 72 is provided to feedback-control the position of the band based on the measured value of the detector in order to reduce the meandering of the casting band 72. Further, position variation of the surface of the casting band 72 just below the die main body 71 in the vertical direction in accordance with the rotation of the rotational roller 73 is preferably controlled within 200 μm.

Note that the rotational rollers 73 and 74 can be used as supports in a direct manner. In this case, it is preferable to rotate the rotational rollers 73 and 74 at high precision while reducing irregularity of rotation to 0.2 mm or less. Further, the average surface roughness of the rotational rollers 73 and 74 is preferably 0.01 μm or less. The rotational rollers 73 and 74 are preferably subjected to the chrome-plating or the like so as to have sufficient hardness and resistance. Note that, surface defect of the supports (the casting band 72 and the rotational rollers 73 and 74) should be reduced to the minimum extent. Concretely, it is preferable that there in no pin holes having a diameter of 30 μm or more, one or less pin hole having a diameter in the range of 10 μm to 30 μm per square meter, and two or less pin holes having a diameter of 10 μm or less per square meter.

The die main body 71, the casting band 72, and the like are included in a casting chamber 76. A temperature controller 77 is attached to the casting chamber 76 to keep the temperature inside the casting chamber 76 to a predetermined value. The temperature in the casting chamber 76 is preferably in the range of −10° C. to 57° C. Additionally, a condenser 78 for condensing and liquidizing the organic solvent vapor is provided in the casting chamber 76. The organic solvent thus condensed and liquidized is recovered by the recovery device 79 to be refined, and then reused as a solvent for preparing a dope.

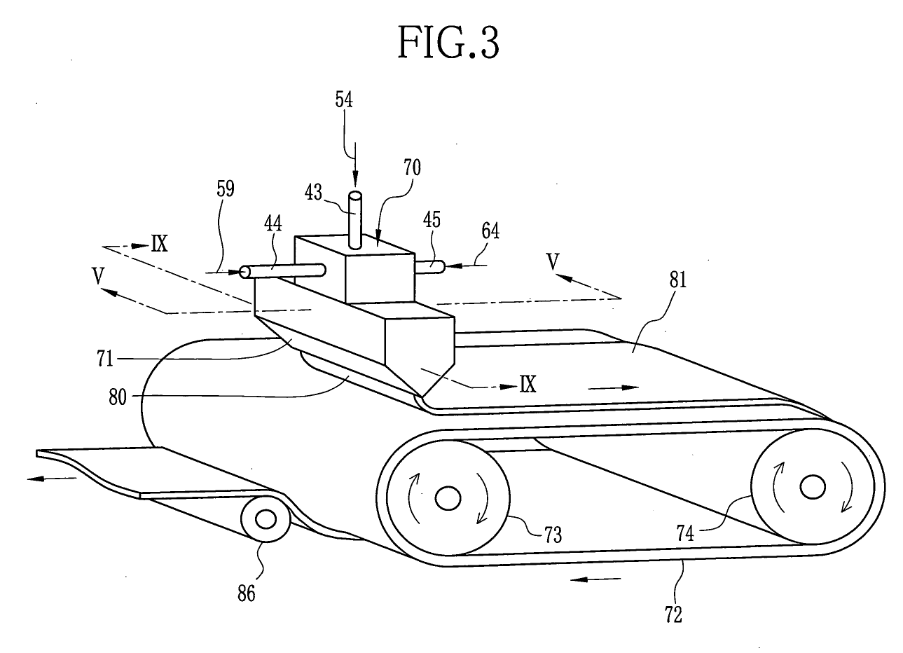

As shown in FIG. 3, the die main body 71 casts a multilayer dope 80, in which the top layer dope 64, the intermediate layer dope 54, and the bottom layer dope 59 form a layer, onto the casting band 72. The multilayer dope 80 extends from the die main body 71 to the casting band 72 to form a casting bead. The multilayer dope 80 cast onto the casting band 72 forms a multilayer casting film 81. Forming the multilayer casting film 81 from the multilayer dope 80 is referred to as co-casting. Note that the temperature of each of the intermediate layer dope 54, the bottom layer dope 59, and the top layer dope 64 is preferably in the range of −10° C. to 57° C.

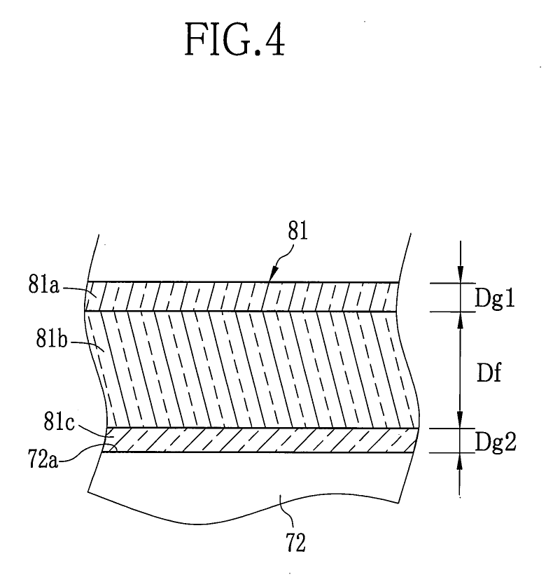

As shown in FIG. 4, the intermediate layer 81b is formed on the bottom layer 81c, and the top layer 81a is formed on the intermediate layer 81b, thus constituting the multilayer casting film 81. The bottom layer 81c consists of the bottom layer dope 59 and is formed on a rear surface of the multilayer casting film 81. Specifically, the rear surface contacts a support surface 72a of the casting band 72. The top layer 81a consists of the top layer dope 64 and is formed on an outer surface of the multilayer casting film 81. The outer surface of the multilayer casting film 81 is opposed to the rear surface. The ratio of thickness of the layers is approximately the same as that in the multilayer dope 80. The intermediate layer 81b consists of the intermediate layer dope 54 and is formed between the top layer 81a and the bottom layer 81c, thus constituting the multilayer casting film 81. When the thickness of the intermediate layer 81b of the multilayer casting film 81 is denoted by Df, the thickness of the top layer 81a thereof is denoted by Dg1, and the thickness of the bottom layer 80c thereof is denoted by Dg2, Dg1/Df is preferably not less than 0.01 and not more than 0.5, and more preferably not less than 0.04 and not more than 0.3. In a case where Dg1/Df is less than 0.01, when the intermediate layer dope 54 has a viscosity higher than that of the top layer dope 64, shearing stress of the multilayer dope 80 at a die lip to be described later increases, and thereby the interface between the intermediate layer 81b and the top layer 81a becomes unstable. As a result, unevenness in thickness occurs. In a case where Dg1/Df is more than 0.5, it becomes difficult to control the thickness distribution of the top layer 81a. For a similar reason, Dg2/Df is preferably not less than 0.01 and not more than 0.5, and more preferably not less than 0.04 and not more than 0.3.

As shown in FIG. 2, a decompression chamber 82 is provided in an upstream side from the die main body 71 in the moving direction of the casting band 72 such that the pressure of the casting bead formed between the die main body 71 and the casting band 72 is adjusted at a predetermined level. The decompression degree of the decompression chamber 82 is preferably adjusted such that the pressure difference between the casting bead in the upstream side from the casting die (upstream side in the moving direction of the casting band 72) and the casting bead in the downstream side from the casting die (downstream side in the moving direction of the casting band 72) is in the range of −10 Pa to 2000 Pa. Further, in order to keep the decompression chamber 82 at a predetermined temperature, it is preferable to provide the decompression chamber 82 with a jacket (not shown). Although the temperature of the casting chamber 82 is not especially limited, the temperature thereof is preferably in the range of 10° C. to 50° C. Additionally, a sucking device (not shown) is preferably attached to an edge of the die main body 71 in order to make the shape of the casting bead more stable to have a desired shape. The sucking wind force is preferably in the range of 1 L/min to 100 L/min.

The multilayer casting film 81 is guided along the moving direction of the casting band 72 in accordance with the moving thereof. Blowers 84a to 84c are preferably provided such that the solvent in the multilayer casting film 81 evaporates. The blowers 84a and 84b are provided above the casting band 72 such that the blower 84a is in the upstream side from the blower 84b, and the blower 84c is provided below the casting band 72 in the drawing. However, the position of each of the blowers 84a to 84c is not limited thereto. Further, a wind shielding device 85 is preferably provided for the purpose of shielding air blown to the multilayer casting film 81 just after being formed, and preventing influence on a surface of the multilayer casting film 81. Note that the casting band 72 is used as the support in the drawing. Alternatively, it is also possible to use a casting drum. In this case, the surface temperature of the casting drum is preferably in the range of −20° C. to 40° C.

The multilayer casting film 81 solidified or having turned into a gel is peeled as a wet film 87 from the casting band 72 with the support of a peel roller 86. Thereafter the wet film 87 is sent to a tenter 100 via a transfer section 90 provided with a plurality of rollers. In the transfer section 90, dry air adjusted at a desired temperature is blown from the blower 91 to the wet film 87, and thereby the drying of the wet film 87 proceeds. At this time the temperature of the dry air is preferably in the range of 20° C. to 250° C. Note that, in the transfer section 90, the rotational speed of the rotational roller in the downstream side is made faster than that of the adjacent rotational roller in the upstream side, thus making it possible to apply draw tension to the wet film 87.

A temperature zone kept at a predetermined drying condition is disposed in the tenter 100. The wet film 87 is transferred to the temperature zone in the tenter 100 while its both side ends are held by clips or the like. When the wet film 87 is transferred to the temperature zone, or while the wet film 87 passes through the temperature zone, solvent contained in the wet film 87 evaporates, and thus the wet film 87 is dried. Moreover, it is preferable that plural temperature zones each having a different drying condition are provided in the tenter 100 in order to adjust the drying conditions. Further, during being dried in the tenter 100, the wet film 87 can be stretched and relaxed in its width direction with use of clips holding both side ends thereof. By stretching and relaxing the wet film 87, it is possible to achieve desired optical properties of the obtained film. The wet film 87 is preferably stretched at least in any one of casting direction and width direction by 0.5% to 300% in the transfer section 90 or the tenter 100.

The wet film 87 is dried in the tenter 100 until the amount of remained solvent achieves a predetermined level, and transferred as a film 101 from the tenter 100. Thereafter, both side ends of the film 101 are cut and removed by a slitting device 102. The both side ends thus cut away are sent to a crusher 103 by a cutter blower (not shown), and crushed into chips by the crusher 103. Reusing the chips to prepare the dope is advantageous in view of cost. Note that the process for slitting the both side ends as described above can be omitted, however the both side ends are preferably cut away in any one of processes between the casting process and a winding process for winding the film.

Next, the film 101 is transferred to a drying chamber 105 provided with plural rollers 104. Although the inside temperature of the drying chamber 105 is not especially limited, the inside temperature is preferably in the range of 50° C. to 180° C. While being wound over the rollers 104 in the drying chamber 105 and transferred, the solvent contained in the film 101 evaporates. Additionally, vapor solvent evaporated from the film 101 in the drying chamber 105 is adsorbed and recovered by an adsorption and recovery device 106 attached to the drying chamber 105. The air, from which solvent component is removed, is sent again as dry air to the drying chamber 105. Note that the drying chamber 150 is preferably divided into a plurality of sections in order to vary the drying temperature in each of the sections. Further, a preliminary drying chamber (not shown) is preferably disposed between the slitting device 102 and the drying chamber 105 to preliminarily dry the film 101. Thereby, it is possible to prevent the rapid change in the temperature of the film 101 in the drying chamber 105, and deformation of the film 101 due to the rapid change in the temperature thereof.

The film 101 is transferred to a cooling chamber 107 to be cooled to approximately room temperature. Note that a humidity control chamber (not shown) may be disposed between the drying chamber 105 and the cooling chamber 107. In the humidity control chamber, air adjusted to have desired humidity and temperature is blown to the film 101. Thereby, it is possible to prevent curing of the film 101 and defect in the winding process.

A compulsory neutralization device (neutralization bar) 108 for regulating the voltage applied to the film 101 during transportation within a predetermined range (for example, in the range of −3 kV to 3 kV) is provided in the downstream from the cooling chamber 107 as shown in the drawing. However, the position of the compulsory neutralization device 108 is not limited thereto. Additionally, in the downstream from the compulsory neutralization device (neutralization bar) 100, there is preferably provided a knurling roller 109 for applying knurling on both side ends of the film 101 by performing emboss processing. Note that the difference in height of the unevenness of the knurling thus applied is preferably in the range of 1 μm to 200 μm.

Finally, the film 101 is wound by a winding roller 111 disposed in a winding chamber 110. At the time of winding, the film 101 is preferably wound while being applied with tension at a desired level by the press roller 112. Note that the tension applied thereto is preferably gradually varied between the start of winding to end of winding. The film 101 to be wound preferably has a length of 100 m or more in the longitudinal direction (casting direction). The film 101 to be wound preferably has a width of 600 mm or more, and more preferably a width of 1400 mm to 1800 mm. The film 101 having a width of 1800 mm or more is also effective. Further, even when the film is as thin as 15 μm to 100 μm, the present invention is applicable.

Next, the feed block 70 and the die main body 71 are described in detail.

[Feed Block]

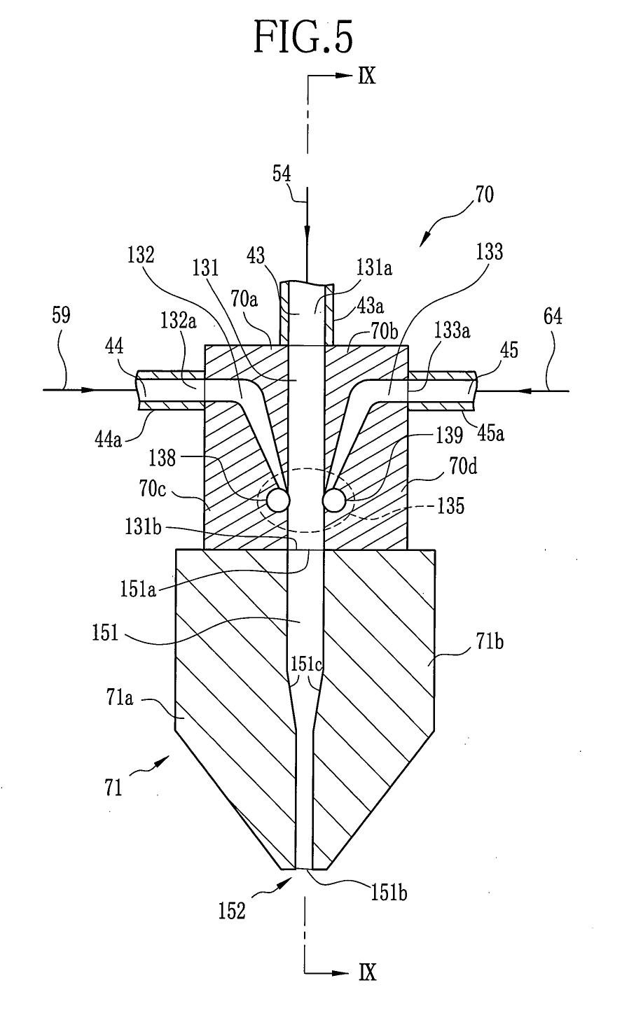

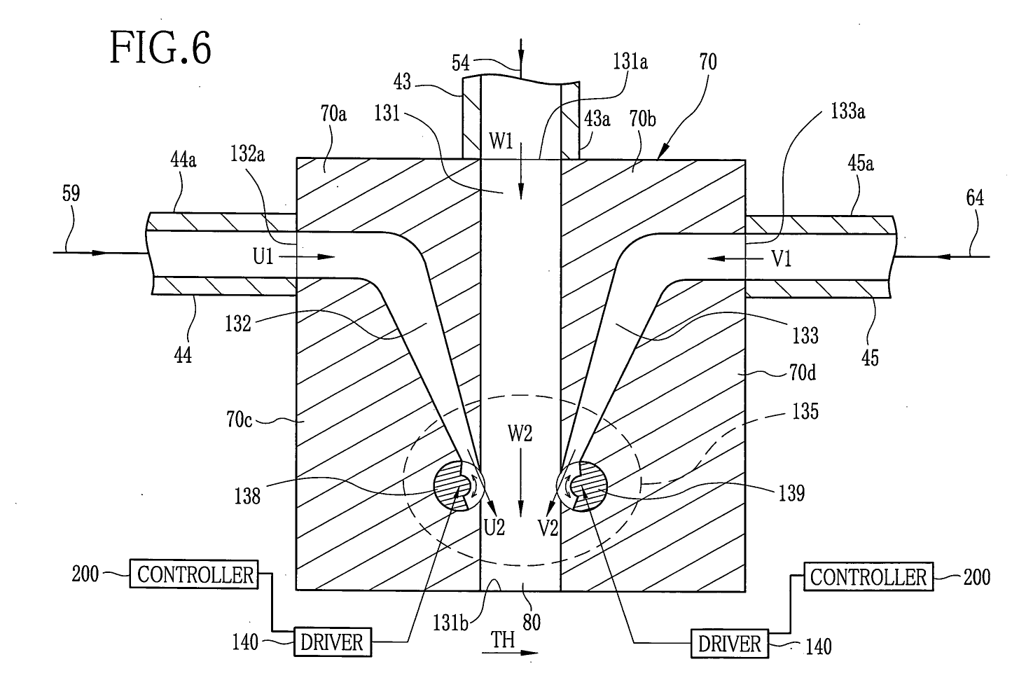

As shown in FIG. 5 and FIG. 6, the feed block 70 includes a first member 70a, a second member 70b, a third member 70c, and a fourth member 70d. The first member 70a, the second member 70b, and a first port member 43a constitute an inlet 131a as an inlet of a first flow channel 131. The first member 70a, the third member 70c, and a second port member 44a constitute an inlet 132a as an inlet of a second flow channel 132. The second member 70b, the fourth member 70d, and a third port member 45a constitute an inlet 133a as an inlet of a third flow channel 133. The inlet 131a of the first flow channel 131 is formed on the upper surface of the feed block 70, and inlets 132a and 133a of the second and third flow channels 132 and 133 are formed on the side surfaces of the feed block 70, respectively. An outlet 131b of the first flow channel 131 is formed on the lower surface of the feed block 70. The inlets 131a, 132a, and 133a are connected to the flow channels 43, 44, and 45, respectively. The first flow channel 131 downwardly extends from the inlet 131a to the outlet 131b so as to penetrate the feed block 70 in the vertical direction. The area of cross section of the first flow channel 131, perpendicular to a flow direction of the intermediate layer dope 54, is approximately constant toward the outlet 131b from the inlet 131a. A joint portion 135 is provided on the way from the inlet 131a to the outlet 131b of the first flow channel 131. The second flow channel 132 extends from the inlet 132a to the joint portion 135. The third flow channel 133 extends from the inlet 133a to the join portion 135. The area of cross section of each of the second and third flow channels 132 and 133, perpendicular to a flow direction of each of the dopes 59 and 64, becomes gradually smaller toward the joint portion 135 from each of the inlets 132a and 133a. A distribution pin 138 is provided on the second flow channel 132 at the vicinity of the joint portion 135. A distribution pin 139 is provided on the third flow channel 133 at the vicinity of the joint portion 135. The distribution pins 138 and 139 are used as an adjusting device for adjusting the flow rate of the dope.

The flow rate of each of the dopes 54, 59, and 64 passing through the first flow channels 131, the second flow channel 132, and the third flow channel 133 is calculated by simulation. In the simulation, the shape (cross section and the length) of each of the first to third flow channels 131 to 133, surface situation of the inner walls of each of the first to third flow channels 131 to 133, flow volume of the pumps 46 to 48, and the shape of each of the distribution pins 138 and 139 are obtained in accordance with the direction of each of the distribution pins 138 and 139. The controller 200 controls the flow volume of the pumps 46 to 48 and the direction of each of the distribution pins 138 and 139 based on the result of simulation in an independent manner, and thereby it is possible to adjust the flow rate of each of the dopes 54, 49, and 64 passing through the first to third flow channels 131 to 133 at an approximately constant level within a predetermined range, respectively. Note that instead of the calculation of the flow rate of each dope by the simulation, it is also possible to arbitrarily attach a flow rate meter to the first to third flow channels 131 to 133, respectively such that the flow rate of each of the dopes is adjusted based on the measured value by the flow rate meter or the like.

Alternatively, a temperature controller and a thermometer (not shown) may be provided in the first to third flow channels 131 to 133 of the feed block 70. The thermometer measures the temperature of dope in each of the first to third flow channels 131 to 133. The temperature controller keeps the temperature of the dope in each of the first to third flow channels 131 to 133 within a predetermined range. The temperature of the dope is controlled based on the measured value obtained by the thermometer. The temperature controller may be a well-known one such as a heater and a jacket capable of containing a heat transfer medium with its temperature kept at a predetermined value. The temperature of each of the dopes is preferably controlled in the range of 25° C. to 60° C. by the temperature controller. In particular, when the main solvent of the dope is dichloromethane, the temperature of the dope is preferably in the range of 25° C. to 38° C. When the main solvent of the dope is methyl acetate, the temperature of the dope is preferably in the range of 25° C. to 55° C.

Moreover, a viscometer (not shown) may be provided in the first to third flow channels 131 to 133 of the feed block 70. The viscometer measures the viscosity of the dope in each of the first to third flow channels 131 to 133. The viscometer may be any well-known one. It is preferable to set the viscosity of the dope 54 to 200 Pa·s or less, and set the viscosity of the dopes 59 and 64 to 60 Pa·s or less. Although the lower limit of the viscosity of each of the dopes 54, 59, and 64 is not especially limited, the lower limit thereof is preferably 40 Pa·s or more in order to make the casting bead stable. Note that, in the present invention, the flow rate, temperature, and viscosity of each of the dopes means one constituting the multilayer dope just after being formed in principle, however are not limited thereto. The flow rate, temperature, and viscosity of each of the dopes also mean the flow rate, temperature, and viscosity of each of the dopes when an interface between the layers constituting the multilayer dope 80 exists.

[Distribution Pin]

Since the distribution pins 138 and 139 are the same structure, the common part thereof is explained by taking the distribution pin 138 as an example. The difference between the distribution pins 138 and 139 is explained in order to omit the description of common part between the distribution pins 138 and 139.

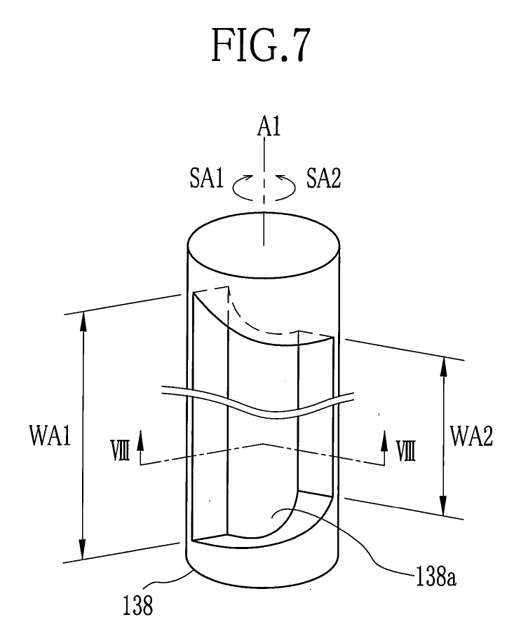

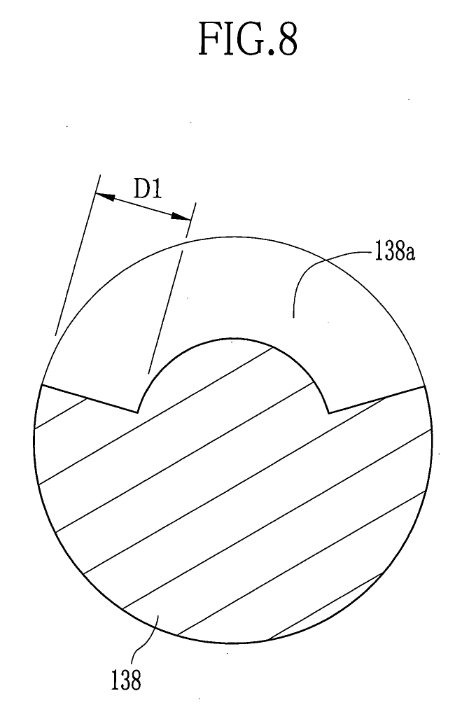

As shown in FIGS. 6 to 8, a cylindrical distribution pin 138 is disposed on the second flow channel 132 at the vicinity of the joint portion 135 so as to extend along the width direction of the multilayer casting film 81. The distribution pin 138 is connected to a driver 140. Further, the driver 140 is connected to the controller 200. The distribution pin 138 is provided so as to be rotatable around the axis A1 thereof, and the driver 140 rotates the distribution pin 138 in the directions SA1 and SA2 shown in the drawing under the control of the controller 200. A cutout groove 138a is formed on the peripheral surface of the distribution pin 138. After passing through the second flow channel 132, the bottom layer dope 59 flows into the joint portion 135 via the cutout groove 138a. The width of the cutout groove 138a gradually changes from the width WA1 to the width WA2 toward the direction SA2. The width of the cutout groove 138a means a length of the cutout groove 138a in the direction of the axis A1 of the distribution pin 138. As shown in FIG. 6, the bottom layer dope 59 flows inside the second flow channel 132 to the joint portion 135 while the width and depth thereof are regulated by the cutout groove 138a. The distribution pin 138 is rotated around the axis A1 in the directions SA1 and SA2, and thereby the area of cross section of the second flow channel 132 at the vicinity of the joint portion 135 can be adjusted.

On the contrary, the cylindrical distribution pin 139 is disposed on the third flow channel 133 at the vicinity of the join portion 135 so as to extend along the width direction of the multilayer casting film 81. A cutout groove similar to the cutout groove 138a is formed on the peripheral surface of the distribution pin 139. The top layer dope 64 in the third flow channel 133 flows to the joint portion 135 while the width and depth thereof are regulated by the cutout groove. The distribution pin 139 is rotated around the axis thereof, and thereby the area of cross section of the third flow channel 133 at the vicinity of the joint portion 135 can be adjusted.

The width D1 of the groove is preferably not less than 0 mm and not more than 5 mm, and more preferably not less than 0 mm and not more than 4 mm. When the width D1 exceeds 5 mm, it may be difficult to obtain film thickness distribution of the outermost layer.

[Casting Die]

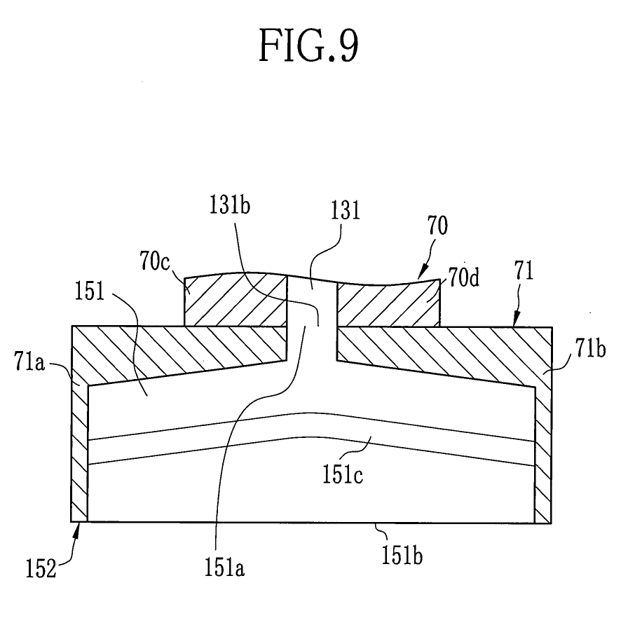

As shown in FIGS. 5 and 9, the die main body 71 consists of a first die main body 71a and a second die main body 71b, and includes a flow channel 151. The first die main body 71a, the second die main body 71b, and the feed block 70 are joined together to form an inlet 151a connecting to the outlet 131b of the feed block 70. A die lip 152 is formed on the lower surface of the die main body 71. An outlet 151b is formed on the die lip 152. The flow channel 151 downwardly extends from the inlet 151a to the outlet 151b so as to penetrate the die main body 71 in a vertical direction. The flow channel 151 has a width gradually increasing from midstream to the outlet 151b. Further, an inclined surface 151c is formed in midstream of the flow channel 151 such that the thickness of the flow channel 151 becomes thinner. A flow rate meter (not shown) is disposed at the vicinity of the die lip 152. The flow rate meter measures a casting speed X1 of the multilayer dope 80 at the outlet 151b.

The width of the multilayer dope 80 supplied from the feed block 70 increases on the way to the outlet 151b of the flow channel 151, and the multilayer dope 80 is discharged from the outlet 151b at the casting speed X1 to form the multilayer casting film 81 on the casting band 72 (FIG. 3). The casting speed X1 of the multilayer dope 80 is not especially limited. For example, in an area with the casting speed X1 of as high as 100 m/min or more (hereinafter referred to as high speed casting area) unevenness in thickness of the multilayer dope 80 occurs more frequently in comparison within an area with low casting speed (hereinafter referred to as low speed casting area). Therefore, when the present invention is applied in the high speed casting area, it is possible to exert the effect of preventing unevenness in thickness of the multilayer dope 80 more efficiently. Note that even when the casting speed X1 is less than 100 m/min, unevenness in thickness of the multilayer dope 80 occurs. Accordingly, when the present invention is applied in low speed casting area, it is possible to prevent occurrence of unevenness in thickness of the multilayer dope 80.

The material for the feed block 70 and the die main body 71 is preferably precipitation hardened stainless steel. A coefficient of thermal expansion thereof is preferably 2×10⁻⁵ (° C.⁻¹) or less. A material whose resistance to corrosion is substantially equivalent to that of SUS316 subjected to a compulsory corrosion examination using an electrolyte aqueous solution may be used for the feed block 70 and the die main body 71. Further, the material has resistance to corrosion such that pitting is not caused on a gas-liquid interface after being soaked in a mixed liquid of dichloromethane, methanol, and water for three months. It is preferable that the material for the die main body 71 is left for one month or more after being cast, and then machined. By virtue of this, the dope can smoothly and uniformly flow inside the die main body 71. Accuracy of finishing of a contact surface between the die main body 71 and the feed block 70 is preferably 1 μm or less in the surface roughness, and straightness thereof is preferably 1 μm/m or less in any direction. An average value of slit clearance can be automatically adjusted within the range of 0.5 mm to 3.5 mm. With respect to a corner portion of a lip edge of the die main body 71, which contacts with liquid, a chamfered radius R thereof is preferably adapted to be 50 μm or less in the entire width. Shearing speed for the dopes 54, 59, and 64 inside of the die main body 71 is preferably adjusted in the range of 1 to 5000 (l/sec).

The die main body 71 is preferably provided with a temperature controller (heater, jacket, and the like, for example) in order to maintain the temperature inside the die main body 71 at a predetermined level during film production. The die main body 71 is preferably of coat-hanger type. Furthermore, it is more preferable that thickness adjusting bolts (heat bolts) are disposed in a width direction of the die main body 71 at predetermined intervals and the die main body 71 is provided with an automatic thickness adjusting mechanism utilizing the heat bolts. As for use of the heat bolts, it is preferable that the heat bolts set a profile along a preset program in accordance with a liquid amount sent by pumps 46 to 48 (preferably high-accuracy gear pumps) for the purpose of producing the film. Additionally, the adjustment amount of the heat bolts may be feedback controlled along an adjustment program on the basis of a profile of a thickness gauge (an infrared thickness gauge, for example, not shown) in the film production line 40. As for the lip clearance, a thickness difference between any two points, which are located within an area except a casting edge portion, of the film is preferably set to be 1 μm or less in the width direction, and the largest thickness difference in the width direction between the minimum values is preferably set to be 3 μm/m or less. Further, as for the accuracy of the lip clearance, the total thickness is preferably regulated to ±1.5% or less.

More preferably, a hardened film is formed on the lip edge of the die main body 71. A method for forming the hardened film is not especially limited, however there are ceramic coating, hard chrome-plating, nitriding treatment, and the like, for example. When the ceramic is utilized as the hardened film, it is preferable that the ceramic can be ground, has low porosity, and is excellent in strength and resistance to corrosion, in addition to excellent adhesion with the die main body 71 and poor adhesion with the dope. Concretely, there are tungsten carbide (WC), Al₂O₃, TiN, Cr₂O₃, and the like. Among those, WC is especially preferable. It is possible to perform WC coating by a thermal spraying method.

It is preferable that a solvent supplying device (not shown) is attached to an end portion of the slit in order to prevent the dope flown to the end portion of the slit of the die main body 71 from being partially dried and solidified. In this case, it is preferable to supply the solvent for solubilizing the dope (such as a mixed solvent of 86.5 parts by weight of dichloromethane, 13 parts by weight of methanol, and 0.5 parts by weight of n-butanol) to the gas-liquid interface between the side ends of the casting bead and the ambient air at the slit. Note that, in supplying the solvent for solubilization, it is preferable to use the pump having a pulsation rate of 5% or less.

Next, a process in which the multilayer casting film 81 is formed from each of the dopes 54, 59, and 64 is described in detail. As shown in FIGS. 2 and 6, the intermediate layer dope 54 flows in the flow channel 43 toward the first flow channel 131 by the pump 46 at a predetermined flow rate W1, and further flows in the first flow channel 131 toward the joint portion 135 at a flow rate W2. On the contrary, the bottom layer dope 59 flows in the flow channel 44 toward the second flow channel 132 by the pump 47 at a predetermined flow rate U1, and further flows in the second flow channel 132 toward the joint portion 135 via the distribution pin 138 at a flow rate U2. Moreover, the top layer dope 64 flows in the flow channel 45 toward the third flow channel 133 by the pump 48 at a predetermined flow rate V1, and further flows in the third flow channel 133 toward the joint portion 135 via the distribution pin 139 at a flow rate V2. Thus, the multilayer dope 80 including the dopes 54, 59, and 64 stacked in a direction TH (as shown in the drawing) is formed in the joint portion 135.

The flow rate W1 of the intermediate layer dope 54 is preferably more than Om/min and not more than 40 m/min, more preferably in the range of 8 m/min to 30 m/min, and most preferably in the range of 10 m/min to 20 m/min. When the flow rate W1 of the intermediate layer dope 54 exceeds 40 m/min, the shearing stress generated in the intermediate layer dope 54 in the flow channel may be too strong.

The flow rate U1 of the bottom layer dope 59 is preferably more than 0 m/min and not more than 15 m/min, more preferably in the range of 3 m/min to 10 m/min, and most preferably in the range of 5.0 m/min to 8 m/min. When the flow rate U1 of the bottom layer dope 59 exceeds 15 m/min, the shearing stress generated in the bottom layer dope 59 in the flow channel may be too strong.

The flow rate V1 of the top layer dope 64 is preferably more than 0 m/min and not more than 15 m/min, more preferably in the range of 3 m/min to 10 m/min, and most preferably in the range of 5 m/min to 8 m/min. When the flow rate V1 of the bottom layer dope 64 exceeds 15 m/min, the shearing stress generated in the top layer dope 64 in the flow channel may be too strong.

The bottom layer dope 59 in the second flow channel 132 flows toward the joint portion 135 while its width and depth are regulated by the cutout groove 138a of the distribution pin 138. The top layer dope 64 in the third flow channel 133 flows toward the joint portion 135 while its width and depth are regulated by the cutout groove of the distribution pin 139. Further, under the control of the controller 200, the driver 140 can adjust the flow rate of each of the dopes within a predetermined range in order to adjust the flow volume of each of the pumps 46 to 48 and the direction of each of the distribution pins 138 and 139, in accordance with the cross section of each of the first to third flow channels 131 to 133, the length thereof, the measured values obtained by the thermometer and viscometer, and the like.

Next, the condition of flow rate of each of the dopes in the present invention is described. As for the proportion of flow rates of dopes, U2/U1 is preferably in the range of 3 to 10, more preferably in the range of 3.5 to 8.5, and most preferably in the range of 3.5 to 5.5. When U2/U1 is less than 3, it may be difficult to control the thickness distribution of the bottom layer 81c. When U2/U1 exceeds 10, the interface between the dope 59 and the dope 54 in the multilayer dope 80 becomes unstable, and thereby occurrence of unevenness in thickness of the multilayer 80 becomes more prominent. Similarly, V2/V1 is preferably in the range of 3 to 10, more preferably in the range of 3.5 to 8.5, and most preferably in the range of 3.5 to 5.5. When V2/V1 is less than 3, it may be difficult to control the thickness distribution of the top layer 81a. When V2/V1 exceeds 10, the interface between the dope 64 and the dope 54 in the multilayer dope 80 becomes unstable, and thereby occurrence of unevenness in thickness of the multilayer dope 80 becomes more prominent. In any cases, the interface between the dope 64 and the dope 54 in the multilayer dope 80 becomes unstable, and unevenness in thickness of the multilayer casting film 81 in the width direction occurs, thus causing an unfavorable result.

Moreover, in addition to the above, U2/W2 is preferably in the range of 0.1 to 1.0, more preferably in the range of 0.3 to 0.8, and most preferably in the range of 0.5 to 0.8. When U2/W2 is less than 0.1, or when U2/W2 exceeds 1.0, the interface between the dope 59 and the dope 54 in the multilayer dope 80 becomes unstable, and unevenness in thickness of the multilayer casting film 81 in the width direction occurs, thus causing an unfavorable result. Note that, V2/W2 is under the same condition as that of W2/W2.

The process for stabilizing the interfaces in the multilayer dope 80 according to the present invention is as follows. The bottom layer dope 59 and the top layer dope 64 are sent to the joint portion 135 through the flow channels 44 and 45, respectively. The area of cross section of each of the flow channels 132 and 133 gradually becomes smaller from each of the inlet 132a and 133a toward the joint portion 135. In flowing through the flow channels 132 and 133, the bottom layer dope 59 and the top layer dope 64 are compressed or stretched, and thus large stress is generated in the bottom layer dope 59 and the top layer dope 64. When the bottom layer dope 59 and the top layer dope 64 described above are sent to the joint portion 135, elastic force due to the stress is generated in the bottom layer dope 59 and the top layer dope 64. The elastic force makes the interfaces between the bottom layer dope 59 and the intermediate layer dope 54 and between the top layer dope 64 and the intermediate layer dope 54 unstable.

According to the present invention, the proportion of flow rates of the bottom layer dope 59 and the top layer dope 64 at each of the inlets 131a to 133a and joint portion 135 is controlled at an approximately constant level within a predetermined range, and thereby the compression and stretch of the bottom layer dope 59 and the top layer dope 64 in the flow channels 132 and 133 are suppressed. As a result, disturbance of interfaces between the dopes in the multilayer dope 80 can be reduced.

Moreover, when the dopes with different viscosity joint in the joint portion 135, difference in shearing stress due to the difference in viscosity occurs, and the difference in viscosity makes interfaces unstable. According to the present invention, since U2/U1, V2/V1, U2/W2, and V2/W2 satisfy the above conditions, it is possible to reduce the difference in the shearing stress in the interfaces between the dopes 59 and 54 and between the dopes 64 and 54 in the joint portion 135. Therefore, according to the present invention, since the proportion of flow rates of the dopes 54, 59, and 64 in the joint portion 135 satisfies a predetermined condition, it is possible to stabilize the interfaces in the multilayer dope 80.

Accordingly, the direction of each of the distribution pins 138 and 139 and the flow volume of each of the pumps 46 to 48 are adjusted as to satisfy the above conditions of flow rates of dopes and the like, and thereby it is possible to reduce the disturbance of interfaces between the dopes in the multilayer dope 80 at high casting speed. Therefore, according to the present invention, it is possible to reduce thickness unevenness of the multilayer dope 80 caused by disturbance of interfaces and produce the film 101 having uniform thickness and the excellent optical properties.

Note that, in the specification, when the flow rate of each of the dopes 54, 59, and 64 is considered, it is not necessary to take the flow direction thereof into consideration. Only the magnitude, that is, the speed may be taken in consideration. Moreover, the flow rates U2, V2, and W2 may be the flow rates of each of the dopes 54, 59, and 64 in the joint portion or in the multilayer dope 80.

In the above embodiment, the surface layer of the multilayer casting film 81 includes the top layer 81a formed on its upper surface and the bottom layer 81c formed on its lower surface. However, the surface layer is not limited thereto. The surface layer of the multilayer casting film 81 may include any one of the top layer 81a and the bottom layer 81c. Alternatively, as the surface layer of the multilayer casting film 81, another layer may be formed on the top layer 81a or the bottom layer 81c. Moreover, in the above embodiment, although the number of the main layer is one, the number thereof is not limited thereto, and the present invention is applicable to a production method of film having a plurality of main layers. In this case, the effect of the present invention can be exerted when the flow rate of the dope for forming the outer layer in contact with one main layer satisfies the above conditions. Additionally, the effect of the present invention can be exerted when the flow rate of the dope for forming the surface layer in contact with one main layer and the flow rate of the dope for forming the main layer satisfy the above conditions.

A detailed descriptions about a structure of the casting die, the decompression chamber, the support, and the like, co-casting, the peeling method, stretching, the drying condition in each process, the handling method, curling, the winding method after correcting smoothness, the solvent recovering method, and the film recovering method are disclosed in paragraphs [0617] to in Japanese Patent Laid-Open Publication No. 2005-104148. The descriptions are also applicable to the present invention.

[Properties and Measuring Method]

(Degree of Curling and Thickness)

The properties of the cellulose acylate film wound up and the measuring method thereof are described in paragraphs [0112] to [0139] in Japanese Patent Laid-Open Publication No. 2005-104148. The descriptions are also applicable to the present invention.

[Surface Treatment]

At least one of the surfaces of the cellulose acylate film is preferably subjected to a surface treatment. The surface treatment is preferably at least one of vacuum glow discharge, plasma discharge under the atmospheric pressure, UV-light irradiation, corona discharge, flame treatment, acid treatment, and alkali treatment.

[Functional Layer]

(Antistatic, Hardened Layer, Antireflection, Easily Adhesion, and Antiglare Function)

At least one of the surfaces of the cellulose acylate film may be subjected to an undercoating process. Further, it is preferable that the cellulose acylate film as the base film, to which other functional layers are added, is used as a functional material. As the functional layer, it is preferable that there is provided one of an antistatic layer, a hardened polymer layer, antireflection layer, an easily adhesive layer, an antiglare layer, and an optical compensation layer.

The functional layer preferably contains at least one kind of surfactants, lubricants, and matting agents in the range of 0.1 mg/m² to 1000 mg/m² each. More preferably, the functional layer contains at least one kind of antistatic agents in the range of 1 mg/m² to 1000 mg/m². Note that, other than the above, the method of forming the surface treatment functional layer for providing the cellulose acylate film with various functions and properties, and the conditions thereof are described in detail in paragraphs [0890] to [1087] in Japanese Patent Laid-Open Publication No. 2005-104148. The descriptions are also applicable to the present invention.

(Application)

The cellulose acylate film described above is effectively used particularly as a protective film for a polarizing filter. A liquid crystal display is obtained by adhering generally two polarizing filters, in which the cellulose acylate film is attached to a polarizer, to a liquid crystal layer. However, the location of the liquid crystal layer and the polarizing filter is not especially limited, and may be located in an arbitrary position based on a various known locations. Details about the liquid crystal displays of TN type, STN type, VA type, OCB type, reflective type, and other types are described in Japanese Patent Laid-Open Publication No. 2005-104148. The description is also applicable to the present invention. Additionally, in the same publication, there are described a cellulose acylate film provided with an optically anisotropic layer, a cellulose acylate film provided with antireflective and antiglare functions, and applications of a biaxial cellulose acylate film provided with adequate optical properties as an optical compensation film. The biaxial cellulose acylate film also may be combined together with the protective film for a polarizing filter. The descriptions are also applicable to the present invention. The details are described in paragraphs [1088] to [1265] in Japanese Patent Laid-Open Publication No. 2005-104148.

Further, according to the present invention, a cellulose triacetate film (TAC film) excellent in optical properties can be obtained. The TAC film can be used as the protective film for a polarizing filter or a base film for photosensitive materials. Additionally, the TAC film can be used as an optical compensation film for improving the dependency on the viewing angle of the display for use in television or the like. In particular, the TAC film is effective in serving as the protective film for a polarizing filter. Therefore, the TAC film is used for not only the conventional TN mode but also IPS mode, OCB mode, VA mode, or the like. Further, the polarizer may be composed of the protective film for a polarizing filter.

Next, examples of the present invention are described.

Hereinafter, Example 1 is described in detail. As to Examples 2, 3 and Comparative Examples 1, 2, conditions different from those of Example 1 are described.

### Example 1

Hereinafter, the present invention is described in detail referring to Example 1. However, the present invention is not limited to thereto. The parts by weight of materials used in Example 1 are as follows.

[Composition]

| | |
|---|---|
| cellulose triacetate (powder having degree of | 100 parts by weight |
| substitution of 2.84, viscosity average | |
| polymerization degree of 306, water content of | |
| 0.2 wt %, viscosity in dichloromethane | |
| solution of 6 wt % of 315 m Pa · s, average | |
| particle diameter of 1.5 mm, and standard | |
| deviation of particle diameter of 0.5 mm) | |
| dichloromethane (first solvent) | 320 parts by weight |
| methanol (second solvent) | 83 parts by weight |
| 1-butanol (third solvent) | 3 parts by weight |
| plasticizer A (triphenyl phosphate) | 7.6 parts by weight |
| plasticizer B (diphenyl phosphate) | 3.8 parts by weight |

[Cotton Compound]

Note that, in cellulose triacetate used in this example, the residual amount of acetic acid was equal to or less than 0. 1 wt %, the rate of content of Ca was 58 ppm, the rate of content of Mg was 42 ppm, the rate of content of Fe was 0.5 ppm, the rate of content of free acetic acid was 40 ppm, and the rate of content of sulfate ion was 15 ppm. The degree of acyl substitution at sixth position was 0.91, and 32.5% of whole acetyl groups was substituted by hydroxyl group at the sixth position. When extraction of cellulose triacetate was applied with acetone, the extract content was 8 wt %. A proportion of weight-average molecular weight to number average molecular weight was 2.5. Note that a yellow index of the obtained TAC was 1.7, the haze thereof was 0.08, the transparency thereof was 93.5%, Tg (glass transition temperature) measured by a differential scanning calorimetry (DSC) was 160° C., and calorific value of crystallization thereof was 6.4 J/g. Cellulose triacetate used in this example was synthesized from cellulose that was extracted from cotton.

(1-1) Preparation of Dope

The dope production line 10 shown in FIG. 1 was used. To the dissolving tank 13 whose content was 4000 L and which was made of stainless, a mixture solvent containing a plurality of solvents was supplied and stirred by the first stirrer 19 and the second stirrer 21 provided in the dissolving tank 13 to be dispersed. Then, cellulose triacetate powders (flakes) were gradually supplied from the hopper 14 thereto such that the total weight of the dissolving tank 13 became 2000 kg. Note that each of the solvent used in this example had water content of 0.5 wt % or less. The second stirrer 21 of dissolver type was caused to stir inside the dissolving tank 13 at a peripheral speed of 5 m/sec (shearing stress: 5×9.8×10⁴ N/m/sec²) at first, and then the first stirrer 19 having an anchor blade at its central shaft was caused to stir inside the dissolving tank 13 at a peripheral speed of 1 m/sec (shearing stress: 1×9.8×10⁴ N/m/sec²), to disperse the cellulose triacetate powders into the mixed solvent for 30 minutes. Note that the temperature at the time of starting dispersing was 25° C., and the temperature finally rose to 48° C. After the dispersion, high-speed stirring was stopped and the peripheral speed of the first stirrer 19 was switched to 0.5 m/sec to stir for 100 minutes. Thereafter, the flaky cellulose triacetate was swelled to obtain the swelling liquid 22. Until the swelling was completed, nitrogen gas was fed into the dissolving tank 13 to pressurize the inside thereof to 0.12 MPa. Further, the oxygen concentration inside the dissolving tank 13 was regulated to less than 2 vol % to maintain a safe state in view of explosion proof. The proportion of water contained in the dope was 0.3 wt %.

(1-2) Dissolution and Filtration

The swelling liquid 22 was supplied from the dissolving tank 13 to the heater 26 by a pump 25 to heat the swelling liquid 22 to 50° C. Then, the swelling liquid 22 was heated to 90° C. under pressurization of 2 MPa to completely dissolve the flaky cellulose triacetate into the solvent. The heating time was 15 minutes. Then, the solution was supplied to the temperature regulator 27 to decrease the temperature thereof to 36° C. The solution was caused to pass the filtration device 28 having a filtration material with pores whose nominal diameter each was 8 μm, thus removing foreign substances in the solution to obtain the dope (hereinafter referred to as dope before concentration) having solid content of 19 wt %. Note that a primary pressure was 1.5 MPa and a secondary pressure was 1.2 MPa in the filtration device 28. The filter, housing, and pipes, which were subjected to high temperature, were made of Hastelloy alloy (trade name), and had excellent resistance to corrosion. A jacket, which was provided in the pipe, circulated heat transfer medium for heating and for heat retention.

(1-3) Concentration, Filtration, Defoaming, and Additive

The dope before concentration was fed into the flash device 31 controlled at a condition of a normal pressure and 80° C., and subjected to flash evaporation to be concentrated. The solvent having evaporated due to the concentration was liquidized by the condenser, and recovered by the recovery device 32. The solid content of the dope after flash evaporation was 21.8 wt %. Note that, the recovered solvent was fed into the refining device 33 and reused as the solvent for preparing dope. A flash tank of the flash device 31 was provided with an anchor blade around its central shaft. The dope after flash evaporation was stirred by the stirrer at a peripheral speed of 0.5 m/sec to be defoamed. The temperature of the dope in the flash tank was 25° C., and the average retention time of the dope in the flash tank was 50 minutes. The dope after concentration was picked to measure its shearing viscosity at the temperature of 25° C. The measured shearing viscosity at a shearing speed of 10 sec⁻¹ was 450 Pa·s.

Next, the dope was irradiated by weak ultrasonic wave to be defoamed. Thereafter the dope pressurized to 1.5 MPa was fed into the filtration device 35 by the pump 34. In the filtration device 35, the dope was caused to pass a sintered fiber metal filter with pores whose nominal diameter each was 10 μm, and then was caused to pass a sintered fiber filter with pores whose nominal diameter each was 10 μm. At this time, primary pressures of the respective filtrations were 1.5 MPa and 1.2 MPa, and secondary pressures of the respective filtrations were 1.0 MPa and 0.8 MPa. After the filtration, the dope with its temperature adjusted to 36° C. was fed into the stock tank 30 whose content was 2000 L and which was made of stainless, to be stored therein. Hereinafter, the dope is referred to as the dope 36. In the stock tank 30, the dope was constantly stirred by the stirrer 42 provided at its central shaft at a peripheral speed of 0.3 m/sec. Note that when the dope 36 was made from the dope before concentration, there occurs no corrosion or the like in respective portions of devices, which contacted the dope. Further, a mixed solvent A containing 86.5 parts by weight of dichloromethane, 13 parts by weight of methanol, and 0.5 parts by weight of 1-butanol was prepared.

(1-4) Discharge, Immediately Before Addition, Casting, and Decompression of Bead

A film was formed by use of the film production line 40 shown in FIG. 2. The dope 36 in the stock tank 30 was sent by the high-accuracy gear pumps 46 to 48 for primary pressurization such that the primary pressure became 0.8 MPa while feed-back control was performed by an inverter motor. The high-accuracy gear pumps 46 to 48 had a volumetric efficiency of 99.2%, and degree of fluctuation of discharge rate was 0.5% or less. The discharge pressure was 1.5 MPa.

The die main body 71 was provided with a feed block 70 having a width of 1.8 m and adjusted for co-casting. The die main body 71 had a structure onto which mainstream of dope and two other streams (sidestream) of dope sandwiching the mainstream of dope therebetween were cast so as to form three-layered film. Note that as flow channels for the dopes, there were used three flow channels, that is, the intermediate layer dope channel 43, the bottom layer dope channel 44, and the top layer dope channel 45.

Ultraviolet absorber (A), ultraviolet absorber (B), a retardation controller (N,N′-di-M-toluoyl-N″-p-methoxyphenyl-1,3,5-triazine-2,4,6-triamine), a mixed solvent 37, and the dope 36 were mixed to obtain the intermediate layer additive liquid 51. The Ultraviolet absorber (A) is 2-(2′-hydroxy-3′,5′-di-tert-butylphenyl)enzotriazole. The ultraviolet absorber (B) is 2-(2′-hydroxy-3,5′-di-tert-amylphenyl)-5-chlorobenzotriazole. Then, the intermediate layer additive liquid 51 was poured into the stock tank 50. The intermediate layer additive liquid 51 was supplied from the stock tank 50 to the dope 36 in the intermediate layer dope channel 43 by the pump 52, to be mixed with the dope 36 by the static mixer 53, thus obtaining the intermediate layer dope 54.

0.05 parts by weight of silicon dioxide (average particle diameter of 15 nm, Mohs hardness of approximately 7) as a matting agent, and 0.006 parts by weight of citric acid ester mixture (citric acid, citrate monoethyl ester, citrate diethyl ester, and citrate triethyl ester) as a release promoting agent, the dope 36, and the mixed solvent A were mixed or dispersed to obtain the bottom layer additive liquid 56. The bottom layer additive liquid 56 was supplied to the stock tank 55, and further a predetermined amount of top layer additive liquid 56 was supplied to the dope 36 in the bottom layer dope channel 44 by use of the pump 57, to be mixed with the dope 36 by the static mixer 58, thus obtaining the bottom layer dope 59. As for the additive amount, total solid content of was 20.5 wt %, the concentration of matting agent in the film form was 0.05 wt %, and the concentration of release promoting agent in the film form was 0.03%.

0.05 parts by weight of silicon dioxide was dispersed into the mixed solvent 37 to prepare the top layer additive liquid 61, and supplied to the stock tank 60. The top layer additive liquid 61 was supplied to the dope 36 in the top layer dope channel 45 by use of the pump 62, to be mixed with the dope 36 by the static mixer 63, thus obtaining the top layer dope 64. As for the additive amount, the total solid content was 20.5 wt %, and the concentration of matting agent in the film form was 0.1 wt %.

Each of the dopes (intermediate layer dope, bottom layer dope, and top layer dope) was cast while the flow volume thereof was adjusted and the casting width was 1700 mm, such that the target TAC film thickness of each of the layer (top layer, intermediate layer, and rear surface) became 4 μm, 73 μm, and 3 μm, and the thickness as a product became 80 μm. In order to adjust the temperature of each of the dopes at 36° C., the die main body 71 was provided with a jacket (not shown), and the inlet temperature of the heat transfer solvent for being supplied to the jacket was set to 36° C.

The temperature of each of the die main body 71, the feed block 70, and the pipe was kept at 36° C. at the time of forming the film. The die main body 71 was a coat-hanger type die and provided with thickness adjusting bolts (heat bolts) at a pitch of 20 mm. The die main body 71 was provided with an automatic thickness adjusting mechanism utilizing heat bolts. The heat bolts could set a profile along a preset program in accordance with a liquid amount sent by a high-accuracy gear pump. Additionally, the heat bolts could perform feedback control along an adjustment program on the basis of a profile of an infrared thickness gauge (not shown) disposed inside the film production line 40. A thickness difference between any two points (separate from each other by 50 mm), which were located within an area except a casting edge portion of 20 mm, of the film was set to be 1 μm or less. Further, the largest thickness difference in the width direction between the minimum values was set to be 3 μm/m. The average thickness accuracy of each layer was regulated to ±2% or less in the top layer and the bottom layer respectively, ±1% or less in the intermediate layer such that the total thickness was regulated to ±1.5% or less.

Each of the dopes 54, 49, and 64 were supplied to the flow channels 131, 132, and 133 from flow channels 43, 44, and 45. The intermediate layer dope 54 was supplied from the inlet 131a to the joint portion 135. The bottom layer dope 59 was supplied through the second flow channel 132 toward the joint portion 135 via the distribution pin 138. The top layer dope 64 was supplied through the third flow channel 133 toward the joint portion 135 via the distribution pin 139. In this embodiment the driver 140 controlled the flow volume of each of the pumps 46 to 48 and the direction of each of the distribution pins 138 and 139 such that V2/V1 became 3.75, U2/U1 became 3.75, V2/W2 became 0.3, and U2/W2 became 0.3.

The decompression chamber 82 used for decompression was disposed in the upstream side from the die main body 71. The decompression degree of the decompression chamber 82 was adjusted such that the pressure difference between the casting bead in the upstream side from the casting die and the casting bead in the downstream side from the casting die was in the range of 1 Pa to 5000 Pa. The adjustment thereof could be performed in accordance with the casting speed. At this time, the pressure difference was set such that the length of the casting bead was in the range of 4 mm±20 mm. The decompression chamber 82 was provided with a mechanism capable of setting the temperature of the decompression chamber 82 higher than the condensation temperature of the gas at the vicinity of the casting portion. The decompression chamber 82 was provided with a labyrinth packing (not shown) in front and rear ends of the casting bead, respectively. Further, the decompression chamber 82 was provided with an aperture on its both ends. Further, the decompression chamber 82 was provided with an edge suction device (not shown) for regulating disturbance of the both side ends of the casting bead.

The material for the die main body 71 was precipitation hardened stainless steel. A coefficient of thermal expansion thereof was 2×10⁻⁵ (° C.⁻¹) or less. A material whose resistance to corrosion was substantially equivalent to that of SUS316 subjected to a compulsory corrosion examination using an electrolyte aqueous solution was used for the die main body 71. Further, the material had resistance to corrosion such that pitting was not caused on a gas-liquid interface after being soaked in a mixed liquid of dichloromethane, methanol, and water for three months. Accuracy of finishing of a contact surface between the die main body 71 and the feed block 70 was 1 μm or less in the surface roughness, and straightness thereof was 1 μm/m or less in any direction. Slit clearance was adjusted at 1.5 mm. With respect to a corner portion of a lip edge of the die main body 71, which contacted with liquid, a chamfered radius R thereof was adapted to be 50 μm or less in the entire width. Shearing speed for the dopes inside of the die main body 71 was adjusted in the range of 1 to 5000 (1/sec). A hardened film was formed on the lip edge of the die main body 71 by performing WC coating by a thermal spraying method.

The mixed solvent for solubilizing the dope was supplied to the gas-liquid interface between the side ends of the casting bead and the ambient air at the slit at the casting speed of 0.5 ml/min at one side for the purpose of preventing the dope flown to the end portion of the slit of the die main body 71 from being partially dried and solidified. The pump for supplying the liquid had a pulsation rate of 5% or less. The pressure of the casting bead in the upstream side from the casting die was lower than that in the downstream side from the casting die by 150 Pa by the decompression chamber 82. The decompression chamber 82 was provided with a jacket (not shown) for the purpose of keeping the temperature inside the decompression chamber 82 at a constant level. Heat transfer medium with its temperature adjusted to 35° C. was supplied to the jacket. The volume of sucked air at the edge was adjustable in the range of 1 L/min to 100 L/min, and in this embodiment, volume of sucked air at the edge was arbitrarily adjusted in the range of 30 L/min to 40 L/min.

A stainless endless band having a width of 2.1 m and length of 70 m was used as the casting band 72 as the support. The surface of the casting band 72 was ground as many times as possible such that the thickness of the casting band 72 became 1.5 mm and the surface roughness became 0.05 μm or less. The casting band 72 was made of SUS316 so as to have sufficient resistance to corrosion and strength. Moreover, unevenness in thickness of the casting band 72 as a whole was 0.5% or less. The casting band 72 was driven by two rotational rollers 73 and 74. The driving of the rotational rollers 73 and 74 was controlled such that the tension caused in the casting band 72 became 1.5×10⁴×9.8 N/m, and such that the difference in relative speed between the casting band 72 and the rotational rollers 73 and 74 became 0.01 m/min or less. Moreover, the speed fluctuation of the casting band 72 was 0.5% or less, and meandering of the casting band 72 in the width direction caused by one rotation was reduced within 1.5 mm by detecting positions of side ends of the casting band 72. Further, position variation between the end of the die lip and the casting band 72 just below the die main body 71 in the vertical direction was 200 μm or less. The casting band 72 was disposed in the casting chamber 76 provided with an air pressure controller (not shown). The multilayer dope 80 including three kinds of dopes (for top layer, intermediate layer, and bottom layer) was cast from the die main body 71 to the casting band 72. The casting speed X1 of the multilayer dope 80 measured by use of a flow rate meter provided in the die lip 152 was 100 m/min.

The heat transfer medium was supplied to the rotational rollers 73 and 74 such that the temperature of the casting band 72 could be controlled. The heat transfer medium adjusted at 5° C. was supplied to the rotational roller 73 at the side of the die main body 71, and the heat transfer medium adjusted at 40° C. was supplied to the rotational roller 74 at the other side. The surface temperature at the center of the casting band 72 immediately before casting was 15° C., and the difference in the temperature between the side ends of the casting band 72 was 6° C. or less. Note that preferably there were no surface defects on casting band 72. Concretely, there were no pin holes having a diameter of 30 μm or more, one or less pin hole having a diameter in the range of 10 μm to 30 μm per square meter, and two or less pin holes having a diameter of 10 μm or less per square meter. Moreover, the moving speed of the casting band 72 was controlled within 10 m/min to 200 m/min.

The temperature in the casting chamber 76 was kept at 35° C. by the temperature controller 77. The multilayer casting film 81 formed from the dope cast on the casting band 72 was dried by dry air of parallel flow at first. The overall heat transfer coefficient to the multilayer casting film 81 by the dry air for drying the multilayer casting film 81 was 24×4.2×10³ J/m²·h·° C. The temperature of the dry air was 135° C. in the upstream side on the casting band 72, and 140° C. in the downstream side on the casting band 72. Further, the blowers 84a to 84c blew the dry air such that the temperature of the dry air was 65° C. below the casting band 72. The saturation temperature of each dry air was approximately −8° C. The oxygen concentration under the dry atmosphere on the casting band 72 was kept at 5 vol %. Note that in order to keep the oxygen concentration at 5 vol %, air is substituted by nitrogen gas. Moreover, in order to condense and recover the solvent in the casting chamber 76, the condenser 78 was disposed therein and the outlet temperature of the condenser 78 was set to −10° C.

For 5 seconds after casting, the wind shielding device 85 prevented the dry air from directly blowing against the multilayer dope 80 and the multilayer casting film 81, and thereby the static pressure fluctuation at the vicinity of the die main body 71 was reduced to ±1 Pa or less. At the time when the ratio of the solvent in the multilayer casting film 81 reached 150 wt % on a dry basis, the multilayer casting film 81 was peeled as the wet film 87 from the casting band 72 with the support of the peel roller 86. The peeling tension applied thereto at this time was 10×9.8×10⁴ N/m. The peeling speed (peel roller draw) was appropriately regulated so as to be in the range of 100.1% to 110% relative to the moving speed of the casting band 72 in order to prevent defect of peeling. Note that the surface temperature of the released wet film 87 was 15° C. The average drying speed of the multilayer casting film 81 on the casting band 72 was 60 wt % (solvent on a dry basis)/min. The solvent vapor generated due to the drying was condensed and liquidized by the condenser 78 set at −10° C. to be recovered by the recovery device 79. The recovered solvent was adjusted to be reused as a solvent for preparing the dope. At this time, the water content of the solvent was adjusted to 0.5% or less. The dry air from which the solvent was removed was heated again and reused as the dry air. The wet film 87 was transferred to the tenter 100 by the support of rollers provided in the transfer section 90. During the transportation, the dry air at the temperature of 40° C. was blown from the blower 91 to the wet film 87. Note that during the transportation with the support of the rollers provided in the transfer section 90, tension of approximately 100N was applied to the wet film 87.

The wet film 87 transferred to the tenter 100 was further transported in the dry zone in the tenter 100 while the side ends thereof were fixed by the clips, and dried by the dry air. The heat transfer medium at the temperature of 20° C. was supplied to the clips to cool the clips. The tenter was driven by a chain, and speed fluctuation of a sprocket was 0.5% or less. Further, the tenter 100 was divided into three zones, and the temperature of the dry air in each of the zones was 90° C., 100° C., and 110° C. from the upstream side in this order. As for the gas composition of the dry air, the saturated gas concentration was −10° C. The average drying speed of the wet film 81 in the tenter 100 was 120 wt % (solvent on a dry basis)/min. The condition of the dry zones was adjusted such that the residual amount of solvent in the film became 7 wt % at the outlet of the tenter 100. The film was stretched in the width direction while being transported in the tenter 100. The increasing amount of the width was 103% when the width of the wet film 87 just after being transported to the tenter 100 was consider as 100%. The stretching rate (tenter driving draw) from the peel roller 86 to the inlet of the tenter 100 was 102%. As for the stretching rate in the tenter 100, the difference in the stretching rate between the inlet of the tenter 100 and a point away from the inlet thereof by 10 mm or more was substantially 10% or less, and the difference in the stretching rate between any two points both of which were far away from the inlet thereof by 20 mm or more was substantially 5% or less. The ratio of the portions which were fixed by the clips at the side ends of the base film was 90%. The solvent vapor in the tenter 100 was condensed at the temperature of −10° C. and liquidized to be recovered. The condenser (not shown) for condensation and recovery was disposed such that the temperature of the outlet thereof was set to −8° C. The water content in the solvent was adjusted to 0.5 wt % or less and reused. Then, the wet film was transferred as the multilayer film from the tenter 100.

The edge slitting device 102 was disposed at a portion to which it took 30 seconds or less from the outlet of the tenter device 100. The edge slitting device 102 cut off the multilayer film at a portion 50 mm away from the both side ends of the multilayer film toward the inward by a NT-type cutter. Further, the both side ends thus cut away (edges) were pneumatically sent to the crusher 103 by a cutter blower (not shown) to be crushed into chips each of which was approximately 80 mm² on average. The chips were reused as a material for preparing a dope together with flaky TAC. The oxygen concentration under the dry atmosphere in the tenter 100 was kept at 5 vol %. Note that in order to keep the oxygen concentration at 5 vol %, air was substituted by nitrogen gas. The multilayer film was preliminarily heated in a preliminary drying chamber (not shown) to which dry air at the temperature of 100° C. was supplied before the multilayer film was dried at a high temperature in the dry chamber 105 to be described later.

The multilayer film was dried a high temperature in the dry chamber 105. The inside of the drying chamber 105 was divided into four sections, and dry air was supplied to each of the sections by the air blower (not shown). The temperature of air supplied by the air blower was 120° C., 130° C., 130° C., and 130° C. in this order from the upstream side. While the multilayer film was transported at the transporting tension of 100 N/width with the support of the rollers 104, the multilayer film was dried for approximately 10 minutes until the residual amount of the solvent definitely became 0.3 wt %. The lap angle of the multilayer film to the rollers 104 was 90 degrees and 180 degrees. The material of the rollers 104 was aluminum or carbon steel. The surface of each of the rollers 104 was subjected to hard chrome-plating, and the one surface thereof was flat, and the other thereof was matted by blast. The fluctuation of the respective rollers 104 due to the rotation was 50 μm or less. Further, deflection of the roller 104 at the transporting tension of 100 N/width was adjusted to be 0.5 mm or less.

The solvent vapor in the dry chamber 105 was recovered and adsorbed by the adsorption and recovery device 106 to be removed. The adsorption and recovery were performed by using activated carbon as absorbing agent and dry nitrogen for desorption. The recovered solvent was adjusted such that the water content thereof became 0.3 wt % or less to be reused as the solvent for preparing the dope. The air inside the dry chamber 105 included substances of high boiling point such as plasticizer, UV-absorbing agent, and the like in addition to the solvent vapor. Therefore, the substances were cooled by a cooling device and removed by preabsorber to be circulated and reused. The absorbing and desorbing conditions were set such that VOC (volatile organic compound) contained in gas exhausted outside became 10 ppm or less at the final stage. The amount of the solvent to be recovered by the condensation method relative to all the solvent vapor was 90 wt %, and most remaining solvent was recovered by absorption and desorption method.

Further, a first humidity control chamber (not shown) and second humidity control chamber (not shown) were disposed between the drying chamber 105 and the cooling chamber 107. The dried multilayer film was transported to the first humidity control chamber. Dry air at the temperature of 110° C. was supplied to the transfer section between the dry chamber 105 and the first humidity control chamber. Air at a temperature of 50° C. and at a dew point of 20° C. was supplied to the first humidity control chamber. Further, the multilayer film was transported to the second humidity control chamber for preventing occurrence of curing of the multilayer film. In the second humidity control chamber, air at a temperature of 90° C. and at a degree of humidity of 70% was directly supplied to the multilayer film.

The multilayer film after the humidity control was fed into the cooling chamber 107 to be cooled until the temperature thereof became 30° C. or less, and then both side ends were slit. Further, the compulsory neutralization device (neutralization bar) 108 was disposed so as to regulate the voltage applied to the film during the transportation in the range of −3 kV to 3 kV constantly. Thereafter, the knurling was formed on the both side ends of the multilayer film by the knurling roller 109. Note that the knurling was formed by performing emboss processing starting from one end of the film to the other end thereof. The width subjected to the knurling was 10 mm, and pressure applied by the knurling roller 109 was set such that the maximum height was higher than the average height by 12 μm on average.

Further, the multilayer film was transported to the winding chamber 110. In the winding chamber 110, the inside temperature was kept at 28° C., and the humidity was kept at 70%. There was disposed a neutralization device utilizing ionic wind (not shown) to regulate the voltage applied to the multilayer film to not less than −1.5 kV and not more than 1.5 kv. Then thickness of the film 101 thus obtained was 80 μm. The winding roller 111 had a diameter of 169 mm. A tension pattern was set such that the tensile force at the time of starting winding became 360 N/width and the tensile force at the time of finishing winding became 250 N/width. The entire length of the wound film was 3940 m. The winding dislocation cycle relative to the winding roller 111 was set to 400 m, and the width of oscillation was set to ±5 mm. Moreover, the pressure applied from the press roller 112 to the winding roller 111 was set to 50 N/width. At the time of winding, the temperature of the film was 25° C., the water content thereof was 1.4 wt %, and the residual amount of the solvent was 0.3 wt %. Through the entire processes, average drying speed of the film was 20 wt % (solvent on a dry basis)/min. Moreover, there were no loosening and wrinkles on the film, and there occurred no winding dislocation under the impact test with 10 G. Moreover, appearance of the roll was excellent.

The film roll of multilayer film was preserved in a storage rack at the temperature of 25° C. and relative humidity (RH) of 55% for one month. Then, the film roll was examined in similar manner as described above. As a result, no predominant change was observed. Further, no adhesion was observed inside the roll. After the production of the multilayer film, there was no remaining multilayer film 81 formed from the dope, which had not been peeled off, on the casting band 72.

### Example 2

In this example, a multilayer film was produced in the same manner as example 1 except that V2/V1 was 5.6, U2/U1 was 5.6, V2/W2 was 0.5, and U2/W2 was 0.5.

### Example 3

In this example, a multilayer film was produced in the same manner as example 1 except that V2/V1 was 8.5, U2/U1 was 8.5, V2/W2 was 0.8, and U2/W2 was 0.8.

### Comparative Example 1

In this example, a multilayer film was produced in the same manner as example 1 except that V2/V1 was 15, U2/U1 was 15, V2/W2 was 1.3, and U2/W2 was 1.3.

### Comparative Example 2

In this example, a multilayer film was produced in the same manner as example 1 except that V2/V1 was 18.75, U2/U1 was 18.75, V2/W2 was 1.7, and U2/W2 was 1.7.

The details of the respective evaluation methods of the multilayer film obtained in each example and the results thereof are shown hereinbelow.

(Measurement of Unevenness in Thickness)

The multilayer film obtained in each example was subjected to measurement of unevenness in thickness. Measurement of unevenness in thickness was performed as follows. At first, a sample film of approximately 6 centimeters square was cut out from the multilayer film obtained in each example. Secondly, the refractive index of the sample film was measured by a device capable of converting the refractive index of the sample film to the thickness difference. FX-03 FRINGE ANALYZER (produced by FUJINON Corporation) was used as the device. Thirdly, the refractive index of the entire sample film was measured, and the average value was considered as unevenness in thickness in each example. When unevenness in thickness thus obtained was less than 1.8% with respect to the thickness of the multilayer film, the measurement result was considered as P (Passed), and when unevenness in thickness thus obtained was 1.8% or more with respect to the thickness of the multilayer film, the measurement result was considered as F (False). Note that the thickness of the multilayer film was obtained by measuring the thicknesses at 6 positions of the multilayer film by use of a micrometer and considering the average value of thicknesses at 6 positions as the thickness of the multilayer film.

TABLE 1

| | 1 | | | | | |
|---|---|---|---|---|---|---|
| | (m/min) | 2 | 3 | 4 | 5 | 6 |
| Example 1 | 100 | 3.75 | 3.75 | 0.3 | 0.3 | P |
| Example 2 | 100 | 5.6 | 5.6 | 0.5 | 0.5 | P |
| Example 3 | 100 | 8.5 | 8.5 | 0.8 | 0.8 | P |
| Comparative | 100 | 15 | 15 | 1.3 | 1.3 | F |
| Example 1 | | | | | | |
| Comparative | 100 | 18.75 | 18.75 | 1.7 | 1.7 | F |
| Example 2 | | | | | | |

Evaluation result in each example is shown in Table 1. Note that Reference numerals 1 to 6 in Table 1 are the casting speed 20 of the multilayer dope 80, the value of U2/U1, the value of V2/V1, the value of U2/W2, the value of V2/W2, and measurement result of unevenness in thickness, respectively.

As shown in Examples 1 to 3, and Comparative Examples 1 and 2, it is possible to reduce the disturbance of the interface in the multilayer dope at high casting speed by regulating the flow rate of each of the dopes such that predetermined conditions are satisfied. Therefore, according to the present invention, it is possible to reduce unevenness in thickness due to the disturbance of interface and produce a large amount of films each having uniform thickness at short times.

The present invention is not to be limited to the above embodiments, and on the contrary, various modifications will be possible without departing from the scope and spirit of the present invention as specified in claims appended hereto.

What is claimed is:

1. A production method of multilayer film having a plurality of layers comprising the steps of:
supplying a first dope through a first inlet of a casting die into said casting die, said casting die flowing out said first dope and a second dope different from each other;
supplying said second dope through a second inlet of said casting die into said casting die;
joining said first dope having passed through a first flow channel and said second dope having passed through a second flow channel together in a joint portion provided in said casting die to form a multilayer dope, said first flow channel connecting said first inlet and said joint portion, said second flow channel connecting said second inlet and said joint portion and having a cross section being gradually smaller toward said joint portion from said second inlet in a direction perpendicular to a flow direction of said second dope, a value of Vo2/Vi2 being approximately constant in a range of 3 to 10, Vo2 being a flow rate of said second dope in said joint portion and Vi2 being a flow rate of said second dope at said second inlet;
casting said multilayer dope from said casting die onto a moving support to form a multilayer casting film;
peeling said multilayer casting film as a wet film from said support; and
drying said wet film to be a multilayer film.

2. A production method of multilayer film described in claim 1, wherein a viscosity of said second dope is lower than a viscosity of said first dope, and a value of Vo2/Vo1 is approximately constant in a range of 0.1 to 1, Vo1 being a flow rate of said first dope in said joint portion.

3. A production method of multilayer film described in claim 2, wherein said first dope is sent to said join portion through said first flow channel having a cross section being approximately constant toward said joint portion from said first inlet in a direction perpendicular to a flow direction of said first dope.

4. A production method of multilayer film described in claim 3, further comprising:
adjusting said flow rate Vi2 of said second dope at said second inlet by a second dope supplying device for supplying said second dope to said second inlet; and
adjusting said flow rate Vo2 of said second dope in said joint portion by an adjusting device provided at said second flow channel at the vicinity of said joint portion.

5. A production method of multilayer film described in claim 4, further comprising:
adjusting said flow rate Vo1 of said first dope in said joint portion by a first dope supplying device for supplying said first dope to said first inlet; and
adjusting said flow rate Vo2 of said second dope in said joint portion by an adjusting device provided at said second flow channel at the vicinity of said joint portion.

6. A production apparatus of multilayer film having a plurality of layers comprising:
a moving support;
a casting die for flowing out a first dope and a second dope different from each other onto said support to form a multilayer casting film such that said first dope and said second dope are stacked, said first dope being guided through a first inlet included in said casting die, said second dope being guided through a second inlet included in said casting die, and said first dope and said second dope being joined together in a joint portion of said casting die to form a multilayer dope;
a first dope supplying device for supplying said first dope to said casting die;
a second dope supplying device for supplying said second dope to said casting die;
an adjusting device for adjusting a flow rate Vo2 of said second dope in said joint portion;
a controlling device for controlling said second dope supplying device and said adjusting device such that a value of Vo2/Vi2 is approximately constant in a range of 3 to 10, Vi2 being a flow rate of said second dope at said second inlet; and
a drier for drying said multilayer casting film peeled from said support to form a multilayer film.

7. A production apparatus of multilayer film described in claim 6, wherein any one of said first dope supplying device, said second dope supplying device, and said adjusting device is controlled by said controlling device such that a value of Vo2/Vo1 is approximately constant in a range of 0.1 to 1, Vo1 being a flow rate of said first dope in said joint portion.

8. A production apparatus of multilayer film described in claim 7, further comprising a first flow channel connecting said first inlet and said joint portion and having a cross section being approximately constant toward said joint portion from said first inlet in a direction perpendicular to a flow direction of said first dope.

9. A production apparatus of multilayer film described in claim 8, wherein said adjusting device is a distribution pin for adjusting said cross section of said second flow channel at the vicinity of said joint portion.

10. A production apparatus of multilayer film described in claim 9, wherein said casting die includes a feed block for forming said multilayer dope from said first dope and said second dope, and a die main body for casting said multilayer dope formed in said feed block to said support.
